(19) United States
(12) Patent Application Publication
(10) Pub. No.: US 2022/0250108 A1
(43) Pub. Date: Aug. 11, 2022

(54) SMART SPRAYER SYSTEMS AND METHODS

(71) Applicant: University of Florida Research Foundation, Incorporated, Gainesville, FL (US)

(72) Inventors: Ioannis AMPATZIDIS, Fort Meyers, FL (US); Victor H. MEIRELLES PARTEL, Leah Acres, FL (US); Lucas FIDELES COSTA, Lehigh Acres, FL (US)

(21) Appl. No.: 17/591,952

(22) Filed: Feb. 3, 2022

Related U.S. Application Data
(60) Provisional application No. 63/199,961, filed on Feb. 5, 2021.

(51) Int. Cl. B05B 12/12; G05B 13/02; B05B 12/16; G01S 17/89

(52) U.S. Cl. CPC B05B 12/122; G01S 17/89; B05B 12/16; G05B 13/0265

(57) ABSTRACT

Embodiments provide methods, apparatus, systems, computing devices, computing entities, assemblies, and/or the like for providing smart agricultural spraying. Various embodiments of the disclosure involve the use of a LiDAR sensor to collect three-dimensional spatial data, one or more cameras to collect images, and a GPS module to collect position and speed measurements of a sprayer as the sprayer travels through an area of interest such as a tree grove. Accordingly, in particular embodiments, a map of the area of interest that may be acquired through UAV imagery, LiDAR measurements, camera images, GPS location and speed measurements, and Artificial Intelligence are used to control the flow of liquid being applied by the sprayer to objects of interest (e.g., trees) as the sprayer travels through the area of interest (e.g., the tree grove).

### CROSS-REFERENCE TO RELATED APPLICATIONS

This application claims priority to U.S. Provisional Patent Application Ser. No. 63/199,961 filed on Feb. 5, 2021, which is incorporated herein by reference in its entirety, including any figures, tables, drawings, and appendices.

### TECHNOLOGICAL FIELD

Embodiments of the present disclosure generally relate to intelligent systems and methods for data collection, processing, and control for providing smart agricultural spraying. The collected data can be used for yield prediction, fruit size and quality prediction, flush detection, development of tree inventory, and/or the like.

### BACKGROUND

Smart and precision agriculture aims to optimize resource usage to achieve enhanced agricultural production and reduced environmental impacts. An important component of optimizing fruit production in many tree groves is spraying the trees in an efficient and effective manner to promote fruit production. However, spraying trees in a grove in such a manner is not a trivial task with respect to determining when sprayers should be turned on and off, determining the rate while sprayers should be applying liquid, and determining which trees need to be sprayed based on the conditions and health of the trees. Accordingly, a need exists in the industry for improved sprayer applications (e.g., spraying trees within a tree grove) that promote optimal agricultural production.

### BRIEF SUMMARY

In general, embodiments of the present invention provide methods, apparatus, systems, computing devices, computing entities, assemblies, and/or the like for providing smart agricultural spraying and/or data collection for other precision agricultural applications (e.g., yield prediction). Accordingly, various embodiments of the disclosure involve the use of a Light Detection and Ranging (LiDAR) sensor to collect three dimensional spatial data, one or more cameras to collect images, and a Global Positioning System (GPS) module to collect position and speed measurements of a sprayer as the sprayer travels through an area of interest such as a tree grove. Accordingly, in particular embodiments, a map of the area of interest that may be acquired through Unmanned Aerial Vehicle (UAV) imagery, LiDAR measurements, camera images, GPS location and speed measurements, and Artificial Intelligence (AI) are used to control the flow of liquid being applied by the sprayer to objects of interest (e.g., trees) as the sprayer travels through the area of interest (e.g., the tree grove).

According to an aspect of the present disclosure, a computer-implemented method for controlling one or more spray zones for a sprayer used for spraying an agricultural area is provided. The computer-implemented method includes filtering one or more light detection and ranging (LiDAR) readings collected from a scan of the agricultural area to obtain a plurality of points pertaining to objects located inside a range of the agricultural area. The computer-implemented method includes classifying each spray zone of the one or more spray zones to be activated in response to the spray zone having at least one of a height for the plurality of points satisfying a height requirement or a number of points for the plurality of points satisfying a point number requirement. The computer-implemented method further includes, for each spray zone classified as a zone to be activated, determining a delay to execute an activation of the spray zone based at least in part on a speed of the sprayer and triggering the activation of the spray zone to cause spraying of at least a portion of the range of the agricultural area after an amount of time based at least in part on the delay.

In various embodiments, the delay is determined based at least in part on a distance between a LiDAR sensor used in obtaining the one or more LiDAR readings minus a spray buffer before the spray zone, the speed of the sprayer, and a cycle time for the valve used for the spray zone. In various embodiments, a duration of time for the activation of the spray zone is determined as a spray buffer after the spray zone plus a spray buffer before the spray zone, and the duration of time is further determined based at least in part on the speed of the sprayer.

According to an aspect of the present disclosure, an apparatus for controlling one or more spray zones for a sprayer used for spraying an agricultural area is provided. The apparatus includes at least one processor and at least one memory having program code stored thereon. The at least one memory and the program code are configured to, with the at least one processor, cause the apparatus to filter one or more light detection and ranging (LiDAR) readings collected from a scan of the agricultural area to obtain a plurality of points pertaining to objects located inside a range of the agricultural area. The at least one memory and the program code are further configured to, with the at least one processor, cause the apparatus to classify each spray zone of the one or more spray zones to be activated in response to the spray zone having at least one of a height for the plurality of points satisfying a height requirement or a number of points for the plurality of points satisfying a point number requirement. The at least one memory and the program code are further configured to, with the at least one processor, cause the apparatus to, for each spray zone classified as a zone to be activated, determine a delay to execute an activation of the spray zone based at least in part on a speed of the sprayer and trigger the activation of the spray zone to cause spraying of at least a portion of the range of the agricultural area after an amount of time based at least in part on the delay.

In various embodiments, the delay is determined based at least in part on a distance between a LiDAR sensor used in obtaining the one or more LiDAR readings minus a spray buffer before the spray zone, the speed of the sprayer, and a cycle time for the valve used for the spray zone. In various embodiments, a duration of time for the activation of the spray zone is determined as a spray buffer after the spray zone plus a spray buffer before the spray zone, and the duration of time is further determined based at least in part on the speed of the sprayer.

According to an aspect of the present disclosure, a non-transitory computer storage medium for controlling one or more spray zones for a sprayer used for spraying an agricultural area is provided. The non-transitory computer storage medium includes instructions configured to cause one or more processors to at least perform operations configured to filter one or more light detection and ranging (LiDAR) readings collected from a scan of the agricultural area to obtain a plurality of points pertaining to objects located inside a range of the agricultural area. The non-transitory computer storage medium includes instructions further configured to cause one or more processors to at least perform operations configured to classify each spray zone of the one or more spray zones to be activated in response to the spray zone having at least one of a height for the plurality of points satisfying a height requirement or a number of points for the plurality of points satisfying a point number requirement. The non-transitory computer storage medium includes instructions further configured to cause one or more processors to at least perform operations configured to, for each spray zone classified as a zone to be activated, determine a delay to execute an activation of the spray zone based at least in part on a speed of the sprayer and trigger the activation of the spray zone to cause spraying of at least a portion of the range of the agricultural area after an amount of time based at least in part on the delay.

In various embodiments, the delay is determined based at least in part on a distance between a LiDAR sensor used in obtaining the one or more LiDAR readings minus a spray buffer before the spray zone, the speed of the sprayer, and a cycle time for the valve used for the spray zone. In various embodiments, a duration of time for the activation of the spray zone is determined as a spray buffer after the spray zone plus a spray buffer before the spray zone, and the duration of time is further determined based at least in part on the speed of the sprayer.

According to another aspect of the present disclosure, a computer-implemented method for generating a tree health status of a tree is provided. The computer-implemented method includes processing one or more images of the tree using a semantic image segmentation machine learning model to detect a canopy area and a leaf area for the tree. The computer-implemented method further includes generating a tree leaf density for the tree based at least in part on the detected canopy area. The computer-implemented method further includes generating, using a leaf classification machine learning model, a leaf classification for the tree based at least in part on the detected leaf area for the tree. The computer-implemented method further includes performing a color analysis for the leaf area based at least in part on the leaf classification. The computer-implemented method further includes generating a tree health status for the tree based at least in part on processing the tree leaf density and the color analysis using a tree health classification machine learning model.

In various embodiments, the computer-implemented method further includes automatically controlling a spray flow for a sprayer configured for spraying a liquid on the tree based at least in part on the generated tree health status. In various embodiments, the one or more images of the tree are generated by one or more cameras affixed to a sprayer used for spraying a liquid on the tree. In various embodiments, the computer-implemented method further includes processing one or more light detection and ranging (LiDAR) readings collected from a scan of an area including the tree to generate a tree height for the tree. The tree health classification machine learning model is configured to process the tree height for the tree to generate the tree health status. In various embodiments, the tree health classification machine learning model includes a gradient boosting regression tree model. In various embodiments, the tree health status is generated for the tree in response to the tree being classified as a mature citrus tree, a young citrus tree, or a dead citrus tree. In various embodiments, the computer-implemented method further includes classifying the tree as at risk or healthy based at least in part on the tree health status.

According to another aspect of the present disclosure, an apparatus for generating a tree health status for a tree is provided. The apparatus includes at least one processor and at least one memory having program code stored thereon. The at least one memory and the program code are configured to, with the at least one processor, cause the apparatus to process one or more images of the tree using a semantic image segmentation machine learning model to detect a canopy area and a leaf area for the tree. The at least one memory and the program code are further configured to, with the at least one processor, cause the apparatus to generate a tree leaf density for the tree based at least in part on the detected canopy area. The at least one memory and the program code are further configured to, with the at least one processor, cause the apparatus to generate, using a leaf classification machine learning model, a leaf classification for the tree based at least in part on the detected leaf area for the tree. The at least one memory and the program code are further configured to, with the at least one processor, cause the apparatus to perform a color analysis for the leaf area based at least in part on the leaf classification. The at least one memory and the program code are further configured to, with the at least one processor, cause the apparatus to generate a tree health status for the tree based at least in part on processing the tree leaf density and the color analysis using a tree health classification machine learning model.

In various embodiments, the at least one memory and the program code are further configured to, with the at least one processor, cause the apparatus to automatically control a spray flow for a sprayer configured for spraying a liquid on the tree based at least in part on the generated tree health status. In various embodiments, the one or more images of the tree are generated by one or more cameras affixed to a sprayer used for spraying a liquid on the tree. In various embodiments, the at least one memory and the program code are further configured to, with the at least one processor, cause the apparatus to process one or more light detection and ranging (LiDAR) readings collected from a scan of an area including the tree to generate a tree height for the tree. The tree health classification machine learning model is configured to process the tree height for the tree to generate the tree health status. In various embodiments, the tree health classification machine learning model includes a gradient boosting regression tree model. In various embodiments, the tree health status is generated for the tree in response to the tree being classified as a mature citrus tree, a young citrus tree, or a dead citrus tree. In various embodiments, the at least one memory and the program code are further configured to, with the at least one processor, cause the apparatus to classify the tree as at risk or healthy based at least in part on the tree health status.

According to another aspect of the present disclosure, a non-transitory computer storage medium for generating a tree health status is provided. The non-transitory computer storage medium includes instructions configured to cause one or more processors to at least perform operations configured to process one or more images of the tree using a semantic image segmentation machine learning model to detect a canopy area and a leaf area for the tree. The non-transitory computer storage medium includes instructions further configured to cause one or more processors to at least perform operations configured to generate a tree leaf density for the tree based at least in part on the detected canopy area. The non-transitory computer storage medium includes instructions further configured to cause one or more processors to at least perform operations configured to generate, using a leaf classification machine learning model, a leaf classification for the tree based at least in part on the detected leaf area for the tree. The non-transitory computer storage medium includes instructions further configured to cause one or more processors to at least perform operations configured to perform a color analysis for the leaf area based at least in part on the leaf classification. The non-transitory computer storage medium includes instructions further configured to cause one or more processors to at least perform operations configured to generate a tree health status for the tree based at least in part on processing the tree leaf density and the color analysis using a tree health classification machine learning model.

In various embodiments, the non-transitory computer storage medium includes instructions further configured to cause one or more processors to at least perform operations configured to automatically control a spray flow for a sprayer configured for spraying a liquid on the tree based at least in part on the generated tree health status. In various embodiments, the one or more images of the tree are generated by one or more cameras affixed to a sprayer used for spraying a liquid on the tree. In various embodiments, The non-transitory computer storage medium includes instructions further configured to cause one or more processors to at least perform operations configured to process one or more light detection and ranging (LiDAR) readings collected from a scan of an area including the tree to generate a tree height for the tree. The tree health classification machine learning model is configured to process the tree height for the tree to generate the tree health status. In various embodiments, the tree health classification machine learning model includes a gradient boosting regression tree model. In various embodiments, the tree health status is generated for the tree in response to the tree being classified as a mature citrus tree, a young citrus tree, or a dead citrus tree. In various embodiments, The non-transitory computer storage medium includes instructions further configured to cause one or more processors to at least perform operations configured to classify the tree as at risk or healthy based at least in part on the tree health status.

According to yet another aspect of the present disclosure, a computer-implemented method for generating a yield estimation for a fruit tree is provided. The computer-implemented method includes processing one or more images of the fruit tree using a fruit detection machine learning model to identify a plurality of fruits for the tree and generate a bounding box for each of the fruits in the plurality of fruits. The computer-implemented method further includes generating a fruit count for the fruit tree based at least in part on the plurality of fruits. The computer-implemented method further includes generating a fruit size for the fruit tree based at least in part on the bounding box generated for each of the fruits in the plurality of fruits. The computer-implemented method further includes processing the fruit count, the fruit size, and a tree health status for the fruit tree using a fruit count estimation machine learning model to generate the yield estimation for the fruit tree.

In various embodiments, the one or more images of the fruit tree are generated by one or more cameras affixed to a sprayer used for spraying a liquid on the fruit tree. In various embodiments, the yield estimation includes a total yield in weight and count of fruit for the fruit tree. In various embodiments, generating the fruit size for the tree includes calculating a diameter for each of the fruits in the plurality of fruits based at least in part on the boarding box generated for each of the fruits in the plurality of fruits to generate a set of diameters and generating the fruit size as an average of the set of diameters. In various embodiments, the fruit detection machine learning model includes a neural network model and the fruit count estimation machine learning model includes a regression model. In various embodiments, the computer-implemented method further includes processing the one or more images to resize the one or more images prior to processing the one or more images using the fruit detection machine learning model.

According to yet another aspect of the present disclosure, an apparatus for generating a yield estimation for a fruit tree is provided. The apparatus includes at least one processor and at least one memory having program code stored thereon. The at least one memory and the program code are configured to, with the at least one processor, cause the apparatus to process one or more images of the fruit tree using a fruit detection machine learning model to identify a plurality of fruits for the tree and generate a bounding box for each of the fruits in the plurality of fruits. The at least one memory and the program code are further configured to, with the at least one processor, cause the apparatus to generate a fruit count for the fruit tree based at least in part on the plurality of fruits. The at least one memory and the program code are further configured to, with the at least one processor, cause the apparatus to generate a fruit size for the fruit tree based at least in part on the bounding box generated for each of the fruits in the plurality of fruits. The at least one memory and the program code are further configured to, with the at least one processor, cause the apparatus to process the fruit count, the fruit size, and a tree health status for the fruit tree using a fruit count estimation machine learning model to generate the yield estimation for the fruit tree.

In various embodiments, the one or more images of the fruit tree are generated by one or more cameras affixed to a sprayer used for spraying a liquid on the fruit tree. In various embodiments, the yield estimation includes a total yield in weight and count of fruit for the fruit tree. In various embodiments, generating the fruit size for the tree includes calculating a diameter for each of the fruits in the plurality of fruits based at least in part on the boarding box generated for each of the fruits in the plurality of fruits to generate a set of diameters and generating the fruit size as an average of the set of diameters. In various embodiments, the fruit detection machine learning model includes a neural network model and the fruit count estimation machine learning model includes a regression model. In various embodiments, the at least one memory and the program code are further configured to, with the at least one processor, cause the apparatus to process the one or more images to resize the one or more images prior to processing the one or more images using the fruit detection machine learning model.

According to yet another aspect of the present disclosure, a non-transitory computer storage medium for generating a yield estimation for a fruit tree is provided. The non-transitory computer storage medium includes instructions configured to cause one or more processors to at least perform operations configured to process one or more images of the fruit tree using a fruit detection machine learning model to identify a plurality of fruits for the tree and generate a bounding box for each of the fruits in the plurality of fruits. The non-transitory computer storage medium includes instructions further configured to cause one or more processors to at least perform operations configured to generate a fruit count for the fruit tree based at least in part on the plurality of fruits. The non-transitory computer storage medium includes instructions further configured to cause one or more processors to at least perform operations configured to generate a fruit size for the fruit tree based at least in part on the bounding box generated for each of the fruits in the plurality of fruits. The non-transitory computer storage medium includes instructions further configured to cause one or more processors to at least perform operations configured to process the fruit count, the fruit size, and a tree health status for the fruit tree using a fruit count estimation machine learning model to generate the yield estimation for the fruit tree.

In various embodiments, the one or more images of the fruit tree are generated by one or more cameras affixed to a sprayer used for spraying a liquid on the fruit tree. In various embodiments, the yield estimation includes a total yield in weight and count of fruit for the fruit tree. In various embodiments, generating the fruit size for the tree includes calculating a diameter for each of the fruits in the plurality of fruits based at least in part on the boarding box generated for each of the fruits in the plurality of fruits to generate a set of diameters and generating the fruit size as an average of the set of diameters. In various embodiments, the fruit detection machine learning model includes a neural network model and the fruit count estimation machine learning model includes a regression model. In various embodiments, the non-transitory computer storage medium includes instructions further configured to cause one or more processors to at least perform operations configured to process the one or more images to resize the one or more images prior to processing the one or more images using the fruit detection machine learning model.

According to a further aspect of the present disclosure, a computer-implemented method for adjusting a flow control valve for a sprayer used for spraying a liquid on a tree located in a region of an agricultural area is provided. The computer-implemented method includes generating, using a variable rate flow model, an application flow rate for the sprayer based at least in part on processing at least one of: global positioning system (GPS) data for the sprayer, an application map providing information on an amount of liquid to apply to the region, and a tree health status of the tree. The variable rate flow model includes a machine learning model and a linear function. The computer-implemented method further includes automatically providing the application flow rate to a flow control system. The flow control system is configured to adjust the flow control valve based at least in part on the application flow rate to control flow of the liquid being applied to the tree located in the region.

In various embodiments, the variable rate flow model includes gradient boosting regression tree with four stages. In various embodiments, the GPS data includes at least one of a location measurement of the sprayer within the agricultural area or a speed measurement of the sprayer.

In various embodiments, the computer-implemented method further includes processing one or more images of the tree using a semantic image segmentation machine learning model to detect a canopy area and a leaf area for the tree. The computer-implemented method further includes generating a tree leaf density for the tree based at least in part on the detected canopy area. The computer-implemented method further includes generating, using a leaf classification machine learning model, a leaf classification for the tree based at least in part on the detected leaf area for the tree. The computer-implemented method further includes performing a color analysis for the leaf area based at least in part on the leaf classification. The computer-implemented method further includes generating a tree health status for the tree based at least in part on processing the tree leaf density and the color analysis using a tree health classification machine learning model.

According to a further aspect of the present disclosure, an apparatus for adjusting a flow control valve for a sprayer used for spraying a liquid on a tree located in a region of an agricultural area is provided. The apparatus includes at least one processor and at least one memory having program code stored thereon. The at least one memory and the program code are configured to, with the at least one processor, cause the apparatus to generate, using a variable rate flow model, an application flow rate for the sprayer based at least in part on processing at least one of: global positioning system (GPS) data for the sprayer, an application map providing information on an amount of liquid to apply to the region, and a tree health status of the tree. The variable rate flow model includes a machine learning model and a linear function. The at least one memory and the program code are further configured to, with the at least one processor, cause the apparatus to automatically provide the application flow rate to a flow control system. The flow control system is configured to adjust the flow control valve based at least in part on the application flow rate to control flow of the liquid being applied to the tree located in the region.

In various embodiments, the variable rate flow model includes gradient boosting regression tree with four stages. In various embodiments, the GPS data includes at least one of a location measurement of the sprayer within the agricultural area or a speed measurement of the sprayer.

In various embodiments, the at least one memory and the program code are further configured to, with the at least one processor, cause the apparatus to process one or more images of the tree using a semantic image segmentation machine learning model to detect a canopy area and a leaf area for the tree. The at least one memory and the program code are further configured to, with the at least one processor, cause the apparatus to generate a tree leaf density for the tree based at least in part on the detected canopy area. The at least one memory and the program code are further configured to, with the at least one processor, cause the apparatus to generate, using a leaf classification machine learning model, a leaf classification for the tree based at least in part on the detected leaf area for the tree. The at least one memory and the program code are further configured to, with the at least one processor, cause the apparatus to perform a color analysis for the leaf area based at least in part on the leaf classification. The at least one memory and the program code are further configured to, with the at least one processor, cause the apparatus to generate a tree health status for the tree based at least in part on processing the tree leaf density and the color analysis using a tree health classification machine learning model.

According to a further aspect of the present disclosure, a non-transitory computer readable medium for adjusting a flow control valve for a sprayer used for spraying a liquid on a tree located in a region of an agricultural area is provided. The non-transitory computer storage medium includes instructions configured to cause one or more processors to at least perform operations configured to generate, using a variable rate flow model, an application flow rate for the sprayer based at least in part on processing at least one of: global positioning system (GPS) data for the sprayer, an application map providing information on an amount of liquid to apply to the region, and a tree health status of the tree. The variable rate flow model includes a machine learning model and a linear function. The non-transitory computer storage medium includes instructions further configured to cause one or more processors to at least perform operations configured to automatically provide the application flow rate to a flow control system. The flow control system is configured to adjust the flow control valve based at least in part on the application flow rate to control flow of the liquid being applied to the tree located in the region.

In various embodiments, the variable rate flow model includes gradient boosting regression tree with four stages. In various embodiments, the GPS data includes at least one of a location measurement of the sprayer within the agricultural area or a speed measurement of the sprayer.

In various embodiments, the non-transitory computer storage medium includes instructions further configured to cause one or more processors to at least perform operations configured to process one or more images of the tree using a semantic image segmentation machine learning model to detect a canopy area and a leaf area for the tree. The non-transitory computer storage medium includes instructions further configured to cause one or more processors to at least perform operations configured to generate a tree leaf density for the tree based at least in part on the detected canopy area. The non-transitory computer storage medium includes instructions further configured to cause one or more processors to at least perform operations configured to generate, using a leaf classification machine learning model, a leaf classification for the tree based at least in part on the detected leaf area for the tree. The non-transitory computer storage medium includes instructions further configured to cause one or more processors to at least perform operations configured to perform a color analysis for the leaf area based at least in part on the leaf classification. The non-transitory computer storage medium includes instructions further configured to cause one or more processors to at least perform operations configured to generate a tree health status for the tree based at least in part on processing the tree leaf density and the color analysis using a tree health classification machine learning model.

According to another aspect of the present disclosure, a housing cover assembly for a light detection and ranging (LiDAR) sensor is provided. The housing cover assembly includes a housing and a nest for the LiDAR sensor configured as a frame to allow seating of the LiDAR sensor through an opening in the housing. The nest includes a base and a spacer connected to the LiDAR sensor and configured to isolate the LiDAR sensor from an outside environment and correctly align the LiDAR sensor.

In various embodiments, the housing cover assembly is configured to protect the LiDAR sensor from physical shocks. In various embodiments, an air blower with a mesh air flow is attached to the housing cover assembly to provide an air flow for maintaining an air pressure to avoid dust accumulation. In various embodiments, the housing cover assembly provides an effective field of view for the LiDAR sensor of at least two-hundred and forty degrees. In various embodiments, the nest for the LiDAR sensor is detachable to enable removal of the LiDAR sensor from the housing.

### BRIEF DESCRIPTION OF THE SEVERAL VIEWS OF THE DRAWING(S)

Having thus described the disclosure in general terms, reference will now be made to the accompanying drawings, which are not necessarily drawn to scale, and wherein:

FIG. 1 is a diagram of a system architecture that can be used in conjunction with various embodiments of the present disclosure;

FIG. 2 is a workflow of data exchange between a smart sprayer system and a cloud environment in accordance with various embodiments of the present disclosure;

FIG. 3 is an example of an application map that can be used in accordance with various embodiments of the present disclosure;

FIG. 4 is a schematic of a computing entity that may be used in conjunction with various embodiments of the present disclosure;

FIG. 5A is an overview of a process flow for the smart sprayer system in accordance with various embodiments of the present disclosure;

FIG. 5B is an overview of a process flow for data collection and processing in accordance with various embodiments of the present disclosure;

FIG. 6 is an example of a sprayer that may be used in accordance with various embodiments of the present disclosure;

FIG. 7 is a schematic of sprayer nozzles, zones, and sides that may be used in accordance with various embodiments of the present disclosure;

FIG. 8 is an example of a power take-off coupling between a tractor and a rear sprayer that may be used in accordance with various embodiments of the present disclosure;

FIG. 9 is an example of a LiDAR housing structure in accordance with various embodiments of the present disclosure;

FIG. 10 is a schematic of a LiDAR housing with air flow in accordance with various embodiments of the present disclosure;

FIG. 11 is a diagram demonstrating a LiDAR effective field of view and blind zones for a LiDAR that may be used in accordance with various embodiments of the present disclosure;

FIG. 12 is a schematic of a LiDAR nest mounting on a LiDAR housing in accordance with various embodiments of the present disclosure;

FIG. 13 is a schematic of the LiDAR position and readings in the smart sprayer system that may be used in accordance with various embodiments of the present disclosure;

FIG. 14 is an example of a RGB camera installed on a sprayer that may be used in accordance with various embodiments of the present disclosure;

FIG. 15 is a schematic showing the top view of the positioning of cameras and LiDAR on a sprayer that may be used in accordance with various embodiments of the present disclosure;

FIG. 16 is a process flow for processing images and generating information thereof in accordance with various embodiments of the present disclosure;

FIG. 17 is a process flow for processing GPS data in accordance with various embodiments of the present disclosure;

FIG. 18 is a process flow for controlling flow via a closed loop control in accordance with various embodiments of the present disclosure;

FIG. 19 is an example of a touch screen monitor that may be used in conjunction with various embodiments of the present disclosure;

FIG. 20 is an example of a user interface that may be used in accordance with various embodiments of the present disclosure;

FIG. 21 is a second example of a user interface that may be used in accordance with various embodiments of the present disclosure;

FIG. 22 is a process flow for controlling nozzles zones and/or individual spray nozzles in accordance with various embodiments of the present disclosure;

FIG. 23A is a process flow for classifying images in accordance with various embodiments of the present disclosure;

FIG. 23B is a configuration of object classifier AI that may be used in accordance with various embodiments of the present disclosure;

FIG. 23C provides an example of classifying an image in accordance with various embodiments of the present disclosure;

FIG. 24A is a process flow for grading and classifying tree health in accordance with various embodiments of the present disclosure;

FIG. 24B is a configuration of tree health AI that may be used in accordance with various embodiments of the present disclosure;

FIG. 24C provides an example of using object classification in grading and classifying tree health in accordance with various embodiments of the present disclosure;

FIG. 24D provides an example of using LiDAR classification and object segmentation in grading and classifying tree health in accordance with various embodiments of the present disclosure;

FIG. 25A is a process flow for controlling flow in accordance with various embodiments of the present disclosure;

FIG. 25B provides a configuration of a flow control system as a closed-looped system that can be used in accordance with various embodiments of the present disclosure;

FIG. 26A is a process flow for generating a yield estimation in accordance with various embodiments of the present disclosure; and

FIG. 26B provides an example of using fruit detection AI in identifying fruits on a tree in accordance with various embodiments of the present disclosure.

### DETAILED DESCRIPTION OF SOME EXAMPLE EMBODIMENTS

Various embodiments of the present disclosure now will be described more fully hereinafter with reference to the accompanying drawings, in which some, but not all embodiments of the disclosure are shown. Indeed, the disclosure may be embodied in many different forms and should not be construed as limited to the embodiments set forth herein; rather, these embodiments are provided so that this disclosure will satisfy applicable legal requirements. The term “or” (also designated as “/”) is used herein in both the alternative and conjunctive sense, unless otherwise indicated. The terms “illustrative” and “exemplary” are used to be examples with no indication of quality level. Like numbers refer to like elements throughout.

### Hardware, Computer Program Products, Systems, Methods, and Computing Entities

Embodiments of the present disclosure may be implemented in various ways, including as hardware and computer program products that comprise articles of manufacture. Such hardware and/or computer program products may include one or more hardware and/or software components including, for example, software objects, methods, data structures, and/or the like. A hardware component may be an article of manufacture and used in conjunction with a software component and/or other hardware components. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of a data structure, apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically configured machines performing the steps or operations specified in the block diagrams and flowchart illustrations. Accordingly, the block diagrams and flowchart illustrations support various combinations of embodiments for performing the specified instructions, operations, or steps.

### Exemplary System Architecture

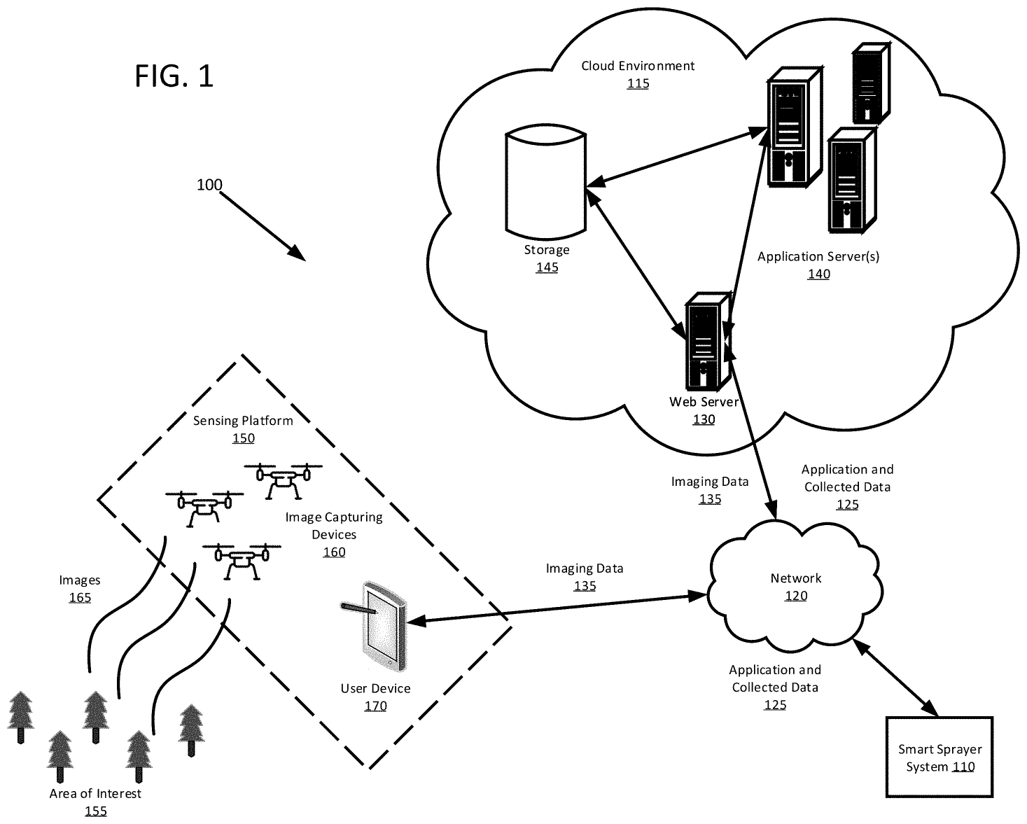

FIG. 1 provides an illustration of a system architecture 100 that may be used in accordance with various embodiments of the disclosure. Here, a smart sprayer system 110 may be in communication with a cloud environment 115 via one or more networks 120 such as the Internet, cellular communication, and/or the like to allow for the exchange of application and collected data 125 as detailed further herein. Accordingly, in various embodiments, the smart sprayer system 110 may comprise hardware and/or software configured for data collection, processing, and control of a sprayer for an agricultural application (e.g., spraying a tree grove). In particular embodiments, the smart sprayer system 110 includes a Light Detection and Ranging (LiDAR) sensor to collect three-dimensional (3D) spatial data of a tree grove, one or more cameras (e.g., RGB cameras) producing images that can be used for applications such as tree or non-tree classification, fruit detection and/or count, fruit size estimation, and/or the like, and a Global Positioning System (GPS) for measuring position and speed. Accordingly, one or more of these various components may be resident on the sprayer.

The cloud environment 115 may be composed of one of several different cloud-based computing solutions that are commercially available, such as Amazon Web Services (AWS), that provides a highly reliable and scalable infrastructure for deploying cloud-based applications. In particular embodiments, the cloud environment 115 provides multiple types of instances, machines with different configurations for specific software applications, and allows for the use of multiple similar machines, the creation of instance images, and the copying of configurations and software applications on an instance.

Here, the cloud environment 115 may include a web server 130 providing one or more websites as a user interface through which remote parties may access the cloud environment 115 to upload and/or download imaging data 135 for processing. In addition, the web server 130 may provide one or more websites through which remote parties may access application, collected, and/or imaging data 125, 135 and process and analyze the data 125, 135 to produce desired information. Furthermore, the cloud environment 115 may include one or more application servers 140 on which services may be available for performing desired functionality such as, for example, processing application, collected, and/or imaging data 125, 135 to produce desired image map(s) and corresponding information for the map(s). Furthermore, the cloud environment 115 may include non-volatile data storage 145 such as a Hard Disc Volume unit for storing application, collected, and/or imaging data 125, 135.

In particular embodiments, a service may be available via the cloud environment 115 that provides a precise map of a tree grove through imagery of the tree grove and Artificial Intelligence (AI). This service may be configured for processing imaging data 135 to detect objects found in the data 135, as well as identify desired parameters for the objects. The service may employ one or more object detection models in various embodiments to detect the objects and corresponding parameters of the objects found in the imaging data 135. Accordingly, in particular embodiments, one or more maps may be generated having information such as tree count, tree measurements, tree canopy leaf nutrient content, yield prediction, and/or the like, as well as one or more soil fertility maps may be generated from soil data processed by laboratory analysis. As detailed further herein, in some embodiments, the service may generate an application map from the various maps with detailed information of how much spraying should be applied by region that is then provided to the smart sprayer system 110.

Accordingly, the cloud environment 115 may be in communication over one or more networks 120 with a sensing platform 150 in various embodiments that is used for image acquisition of an area of interest 155 that includes one or more image capturing devices 160 configured to acquire one or more images 165 of the area of interest 155. For instance, the area of interest 155 may be a tree grove and the one or more image capturing devices 160 may be quadcopter Unmanned Aerial Vehicles (UAVs) such as, for example, a Matrice 210 or DJI Phantom 4 Pro+ used for capturing aerial images of the tree grove. The system architecture 100 is shown in FIG. 1 with a sensing platform 150 using UAVs. However, those of ordinary skill in the art should understand that other sensing platforms 150 including other types of image capturing devices 160 can be used in other embodiments depending on the application (e.g., agriculture application) for which images are being gathered.

Accordingly, the image capturing devices 160 in the sensing platform 150 use one or more sensors for capturing the images 165 such as, for example, multispectral cameras and/or RGB cameras. For instance, images may be acquired on five bands: (i) blue, (ii) green, (iii) red, (iv) red edge, and (v) near-infrared. Further, the imaging resolution may vary depending on the application such as, for example, 5,280×3,956 pixels (21 megapixels) or 5,472×3,648 (19.96 megapixels).

In addition, the sensing platform 150 may include a user device 170 for controlling the image capturing devices 160. Here, the user device 170 may include some type of application used for controlling the image capturing devices 160. For example, Pix4DCapture software may be utilized in particular instances in which aerial images 165 are being collected for flight planning and mission control. Accordingly, the sensing platform 150 negotiates the area of interest 155 (e.g., negotiates having the UAVs fly over the tree grove) and captures images 165 that can then be uploaded to the cloud environment 115. Here, the images 165 are captured using the image capturing devices 160 and collected on the user device 170. The user device 170 may then access the cloud environment 115 via a website over a network 120, such as the Internet, cellular communication, and/or the like, and upload the imaging data 135.

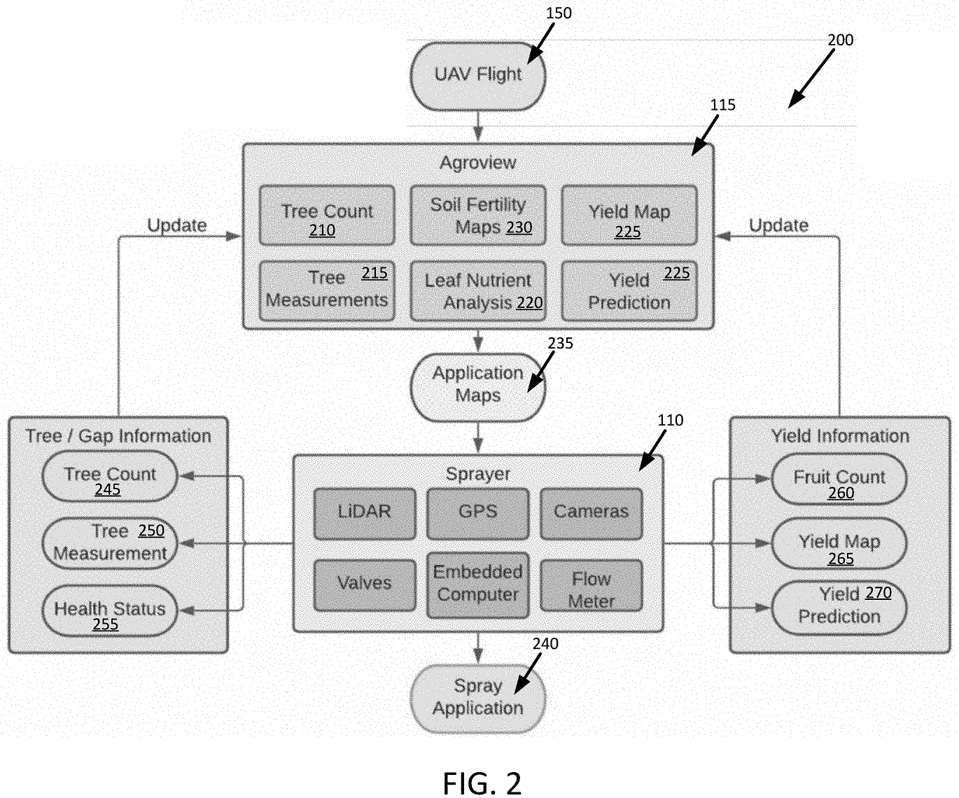

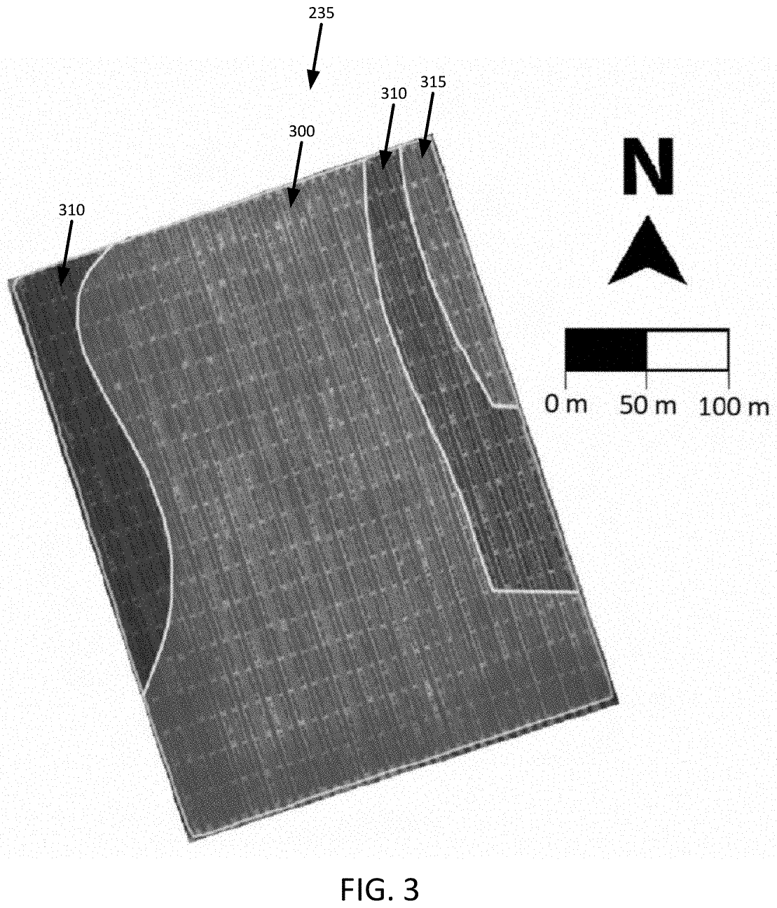

Turning now to FIG. 2, a workflow of data exchange 200 between the smart sprayer system 110 and the cloud environment 115 according to various embodiments is shown. As previously noted, the cloud environment 115 may receive imaging data 135 of an area of interest 155 from a sensing platform 150. The cloud environment 115 may then process the imaging data 135 in generating one or more maps having information such as tree count 210, tree measurements 215, tree canopy leaf nutrient content 220, yield prediction 225, and/or the like, as well as one or more soil fertility maps 230 may be generated from soil data processed by laboratory analysis. Accordingly, the cloud environment 115 may generate an application map 235 from the various maps with detailed information of how much spraying should be applied by region that is provided to the smart sprayer system 110 as application data 125. An example of an application map 235 is shown in FIG. 3. Each region 300, 310, 315 of the application map 235 corresponds to a different application rate by the sprayer. As detailed further herein, the smart sprayer system 110 may then use the application map 235 in a spray application 240 to control flow of liquid being applied to trees in the area of interest (e.g., the tree grove) 130.

In addition, the smart sprayer system 110 in various embodiments collects and processes data 125 that can be communicated to the cloud environment 115. For instance, such data 125 may include tree count 245, tree measurements 250, tree health status 255, fruit count and/or fruit size estimation 260, yield map 265, yield prediction 270, fruit quality estimation, flush detection, flower count and/or flower size, and/or the like. Accordingly, in some embodiments, the cloud environment 115 may use such collected data 125 in updating the information on the various maps generated by the cloud environment 115, creating a robust and precise layer of information for growers.

### Exemplary Computing Entity

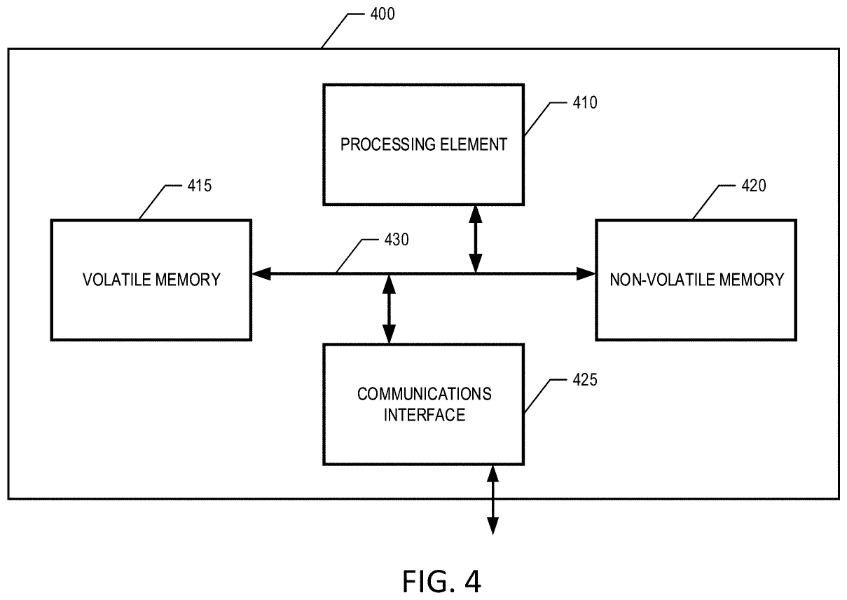

FIG. 4 provides a schematic of a computing entity 400 according to various embodiments of the present disclosure. For instance, the computing entity 400 may be the web server(s) 130 and/or application server(s) 140 found within the cloud environment 115, as well as an embedded computer found within the smart sprayer system 110 previously described in FIG. 1. In general, the terms computing entity, entity, device, system, and/or similar words used herein interchangeably may refer to, for example, one or more computers, computing entities, desktop computers, mobile phones, tablets, phablets, notebooks, laptops, distributed systems, items/devices, terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

Although illustrated as a single computing entity, those of ordinary skill in the art should understand that the computing entity 400 shown in FIG. 4 may be embodied as a plurality of computing entities, tools, and/or the like operating collectively to perform one or more processes, methods, and/or steps. As just one non-limiting example, the computing entity 400 may comprise a plurality of individual data tools, each of which may perform specified tasks and/or processes.

Depending on the embodiment, the computing entity 400 may include one or more network and/or communications interfaces 425 for communicating with various computing entities, such as by communicating data, content, information, and/or similar terms used herein interchangeably that can be transmitted, received, operated on, processed, displayed, stored, and/or the like. Depending on the embodiment, the networks used for communicating may include, but are not limited to, any one or a combination of different types of suitable communications networks such as, for example, cable networks, public networks (e.g., the Internet), private networks (e.g., frame-relay networks), wireless networks, cellular networks, telephone networks (e.g., a public switched telephone network), or any other suitable private and/or public networks. Further, the networks may have any suitable communication range associated therewith and may include, for example, global networks (e.g., the Internet), MANs, WANs, LANs, or PANs. In addition, the networks may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, satellite communication mediums, or any combination thereof, as well as a variety of network devices and computing platforms provided by network providers or other entities.

Accordingly, such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the computing entity 400 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. The computing entity 400 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

In addition, in various embodiments, the computing entity 400 includes or is in communication with one or more processing elements 410 (also referred to as processors, processing circuitry, and/or similar terms used herein interchangeably) that communicate with other elements within the computing entity 400 via a bus 430, for example, or network connection. As will be understood, the processing element 410 may be embodied in several different ways. For example, the processing element 410 may be embodied as one or more complex programmable logic devices (CPLDs), microprocessors, multi-core processors, coprocessing entities, application-specific instruction-set processors (ASIPs), and/or controllers. Further, the processing element 410 may be embodied as one or more other processing devices or circuitry. The term circuitry may refer to an entirely hardware embodiment or a combination of hardware and computer program products. Thus, the processing element 410 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 410 may be configured for a particular use or configured to execute instructions stored in volatile or non-volatile media or otherwise accessible to the processing element 410. As such, whether configured by hardware, computer program products, or a combination thereof, the processing element 410 may be capable of performing steps or operations according to embodiments of the present disclosure when configured accordingly.

In various embodiments, the computing entity 400 may include or be in communication with non-volatile media (also referred to as non-volatile storage, memory, memory storage, memory circuitry and/or similar terms used herein interchangeably). For instance, the non-volatile storage or memory may include one or more non-volatile storage or memory media 420 such as hard disks, ROM, PROM, EPROM, EEPROM, flash memory, MMCs, SD memory cards, Memory Sticks, CBRAM, PRAM, FeRAM, RRAM, SONOS, racetrack memory, and/or the like. As will be recognized, the non-volatile storage or memory media 420 may store files, databases, database instances, database management system entities, images, data, applications, programs, program modules, scripts, source code, object code, byte code, compiled code, interpreted code, machine code, executable instructions, and/or the like. The term database, database instance, database management system entity, and/or similar terms used herein interchangeably and in a general sense to refer to a structured or unstructured collection of information/data that is stored in a computer-readable storage medium.

In particular embodiments, the memory media 420 may also be embodied as a data storage device or devices, as a separate database server or servers, or as a combination of data storage devices and separate database servers. Further, in some embodiments, the memory media 420 may be embodied as a distributed repository such that some of the stored information/data is stored centrally in a location within the system and other information/data is stored in one or more remote locations. Alternatively, in some embodiments, the distributed repository may be distributed over a plurality of remote storage locations only. As already discussed, various embodiments contemplated herein include cloud data storage in which some or all the information/data required for use with various embodiments of the disclosure may be stored.

In various embodiments, the computing entity 400 may further include or be in communication with volatile media (also referred to as volatile storage, memory, memory storage, memory circuitry and/or similar terms used herein interchangeably). For instance, the volatile storage or memory may also include one or more volatile storage or memory media 415 as described above, such as RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. As will be recognized, the volatile storage or memory media 415 may be used to store at least portions of the databases, database instances, database management system entities, data, images, applications, programs, program modules, scripts, source code, object code, byte code, compiled code, interpreted code, machine code, executable instructions, and/or the like being executed by, for example, the processing element 410. Thus, the databases, database instances, database management system entities, data, images, applications, programs, program modules, scripts, source code, object code, byte code, compiled code, interpreted code, machine code, executable instructions, and/or the like may be used to control certain aspects of the operation of the computing entity 400 with the assistance of the processing element 410 and operating system.

With respect to the computing entity 400 being the embedded computer within the smart sprayer system 110, the computing entity 400 may be configured in various embodiments to process data from one or more sensors used for the sprayer. Accordingly, in particular embodiments, the computing entity 400 may have a processing element 410 that comprises both a central processing unit (CPU) and graphical processing unit (GPU), making it suitable for machine vision applications (e.g., making it suitable for machine vision applications that require computer unified device architecture cores). In some embodiments, the computing entity 400 is configured to process data in real time and output one or more signals to a microcontroller. The microcontroller then reads the signal(s) and activates requested relays to control the sprayer, such as, for example, control the sprayer's electric valves.

The communication protocol that can be used in various embodiments between the computing entity 400 and the microcontroller is a Controller Area Network (CAN bus). For example, in particular embodiments, a pair of circuit boards that convert Universal Asynchronous Receiver/Transmitter (UART) to CAN bus can be used to connect the network to the computing entity 400 and microcontroller UART pins. Accordingly, the CAN bus protocol may be used due to its robustness and tolerance to electro-magnetic interference.

As will be appreciated, one or more of the computing entity's components may be located remotely from other computing entity components, such as in a distributed system. Furthermore, one or more of the components may be aggregated and additional components performing functions described herein may be included in the computing entity 400. Thus, the computing entity 400 can be adapted to accommodate a variety of needs and circumstances.

### Exemplary System Configuration

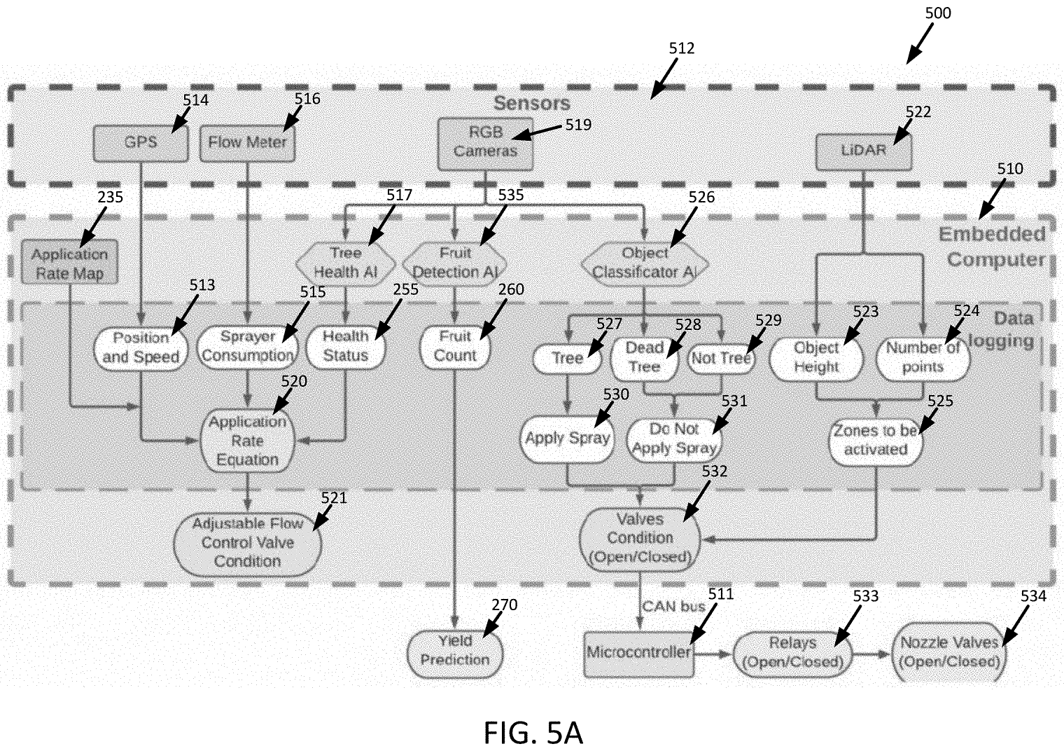

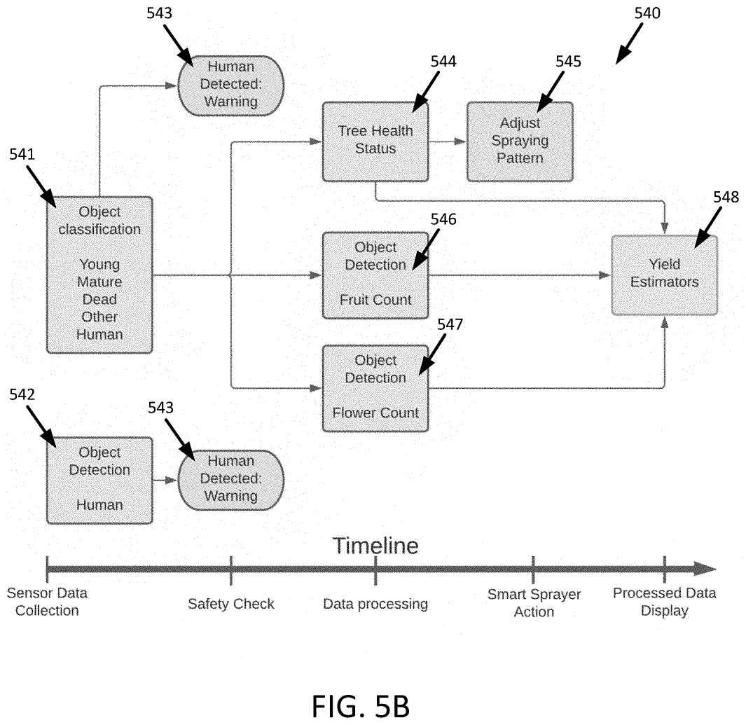

As previously described, the smart sprayer system 110 in various embodiments includes hardware and software configured for collecting and processing of data for the purpose of controlling a sprayer used for spraying an area of interest 155 such as a tree grove. Accordingly, FIG. 5A provides an overview of a configuration 500 for a smart sprayer system 110 according to various embodiments. Here, the configuration 500 includes a control unit (e.g., embedded computer 510 and microcontroller 511) configured for gathering (e.g., reading, requesting, receiving, and/or the like) various sensor readings from different sensors 512, processing the sensor readings using various equations and AI, and issuing command outputs to components of the sprayer.

For instance, in particular embodiments, the smart sprayer system 110 may be configured for adjusting a flow control valve for controlling the flow of liquid being applied by the sprayer to a region in the tree grove. Accordingly, in these particular embodiments, the embedded computer 510 is configured to gather GPS data 513, such as position and speed of the sprayer, from a GPS module 514. In addition, the embedded computer 510 is configured to gather one or more sprayer consumption measurements 515 from a flow meter 516 measuring liquid flow for the sprayer. The embedded computer 510 processes images of the region of the tree grove produced from one or more cameras 519 on the sprayer using tree health AI 517 to generate a tree health status 255 of one or more trees detected in the region. The embedded computer 510 then processes the GPS data 513, sprayer consumption measurement(s) 515, and tree health status 255 using an application rate equation (model) 520 to generate an adjustable flow control valve condition 521 (e.g., an application rate) that is then sent to a flow control system and used to control flow of liquid being applied by the sprayer to the region. In some embodiments, the application map 235 may also be used in generating the adjustable flow control valve condition. 521.

In addition, in particular embodiments, the smart sprayer system 110 may be configured to control the valves for various spray nozzles found in spray zones and/or control individual spray nozzles for the sprayer. Here, the embedded computer 510 is configured to gather the images from the cameras 519 and measurements from a LiDAR sensor 522. Accordingly, the embedded computer 510 generates an object height 523 and number of points 524 for objects detected from the LiDAR measurements and identifies what spray zones and/or individual spray nozzles should be activated 525 accordingly. In some embodiments, the smart sprayer system 110 uses a classification of the detected objects to override the activation of certain spray zones and/or nozzles, if required. In these embodiments, the embedded computer 510 uses object classification AI 526 to classify the objects from the images as a living tree 527, a dead tree 528, an at risk tree, not a tree 529, and/or the like. As a result, the embedded computer 510 determines whether the spray nozzles in the various zones and/or individual spray nozzles should or should not be applied 530, 531 based at least in part on the classification, and generates valve conditions 532 indicating whether to open or close the valves for the spray nozzles in the various spray zones and/or individually and sends the valve conditions 532 to the microcontroller 511. In turn, the microcontroller 511 relays instructions 533 to the various spray nozzle flow control valves 534, and the spray nozzle flow control valves 534 open or close accordingly.

Further, in particular embodiments, the smart sprayer system 110 may be configured to generate yield predictions for various trees found in the tree grove based at least in part on the images of trees obtained by the cameras 519 and/or fruit and/or flower counts derived from the images. Specifically, the embedded computer 510 may be configured to process the image(s) of a tree using fruit detection AI 535 to generate fruit and/or flower count and/or size estimation(s) 260 for the tree. The fruit and/or flower count and/or size (e.g., in diameter) estimation(s) 260 may then be used in generating a yield prediction 270 for the tree. For example, the yield prediction 270 may be an estimate of the tree's total yield in weight and count.

Turning to FIG. 5B, an overview of a process flow 540 with respect to data collection and processing accordingly to various embodiments. Here, after sensor readings are collected, two initial processes may be conducted that include object classification 541 and object detection 542. As previously noted, object classification 541 may involve using object classification AI 526 to classify objects from images as, for example a living tree, a dead tree, an at risk tree, not a tree (e.g., human), and/or the like. In particular embodiments, the object detection 542 may be carried out as a safety measure and may involve using object detection AI to search the images and identify objects (e.g., locate and classify objects) in the images as humans. Accordingly, the smart sprayer system 110 may be configured to issue a warning 543 if either the object classification 541 or object detection 542 identifies a human in an image.

In addition, if the object classification 541 classifies an object in an image as a “young tree,” “mature tree,” or “dead tree,” the process flow 540 continues in various embodiments with a tree health status process 544 for generating a tree health status 255 and, in some instances, double checking the classification. Accordingly, in particular embodiments, the output from the tree health status process 544 may be used for adjusting the spraying pattern 545. Further, the process flow 540 may involve conducting object detection 546, 547 to generate fruit and/or flower count and/or size estimation(s). Here, as previously noted, the object detection 546, 547 may involve processing the image(s) of a tree using fruit detection AI 535 to generate the fruit and/or flower count and/or size (e.g., in diameter) estimation(s) 260 for the tree. The fruit and/or flower count and/or size estimation(s) 260 may then be used by one or more yield estimators 548 in generating a yield prediction 270 for the tree. Accordingly, after the data is collected and processed, the data may be uploaded in particular embodiments to a cloud environment 115 for further processing.

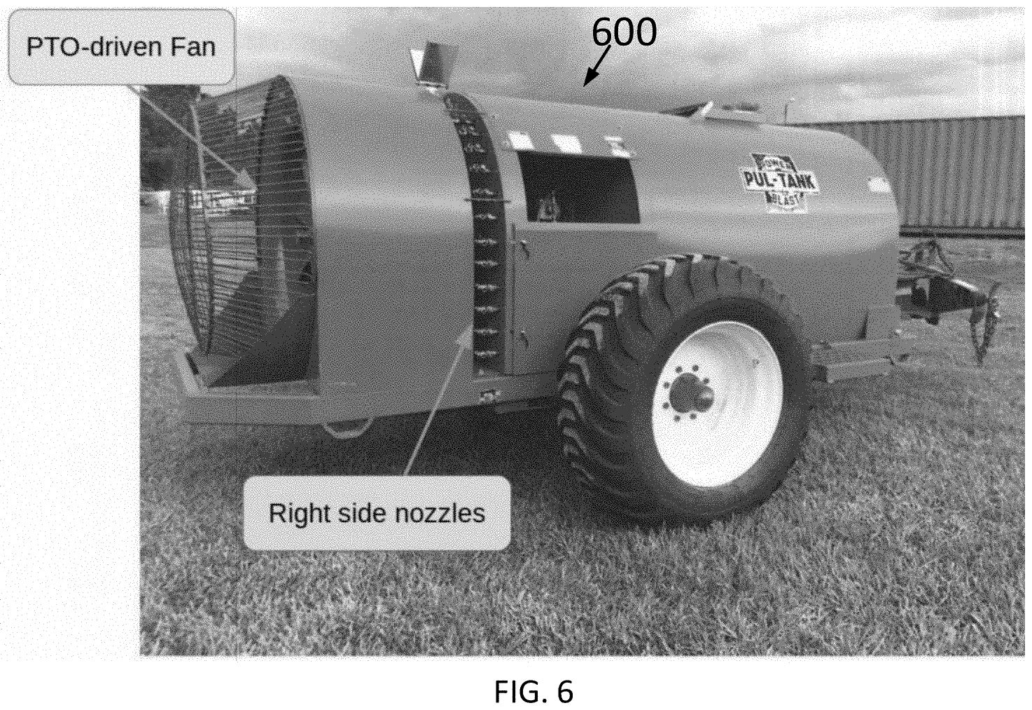

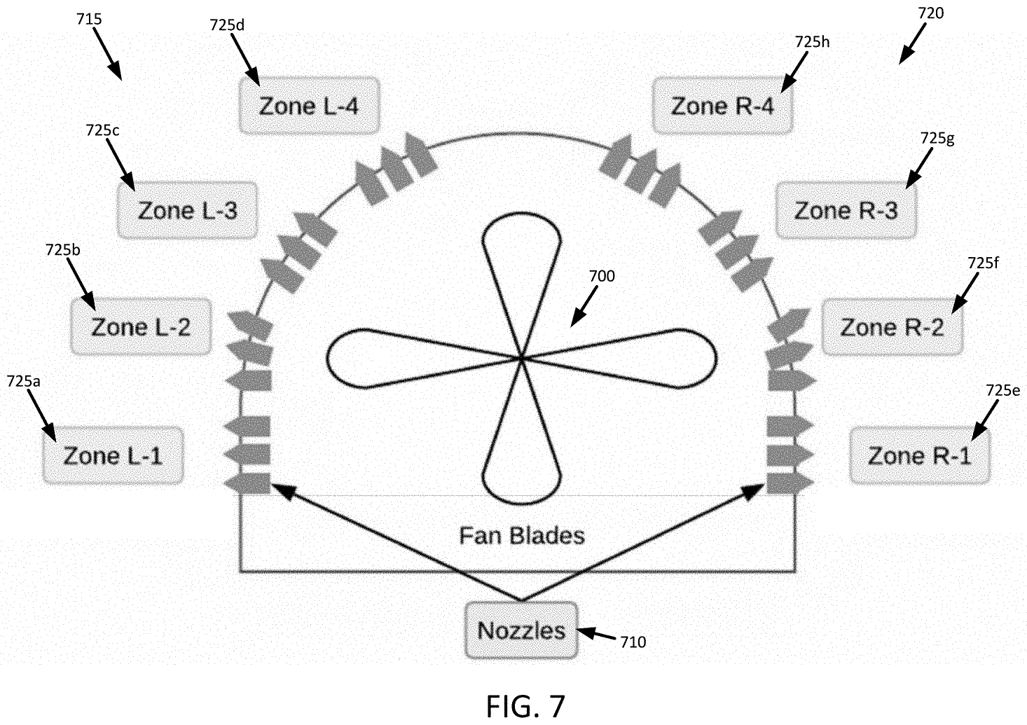

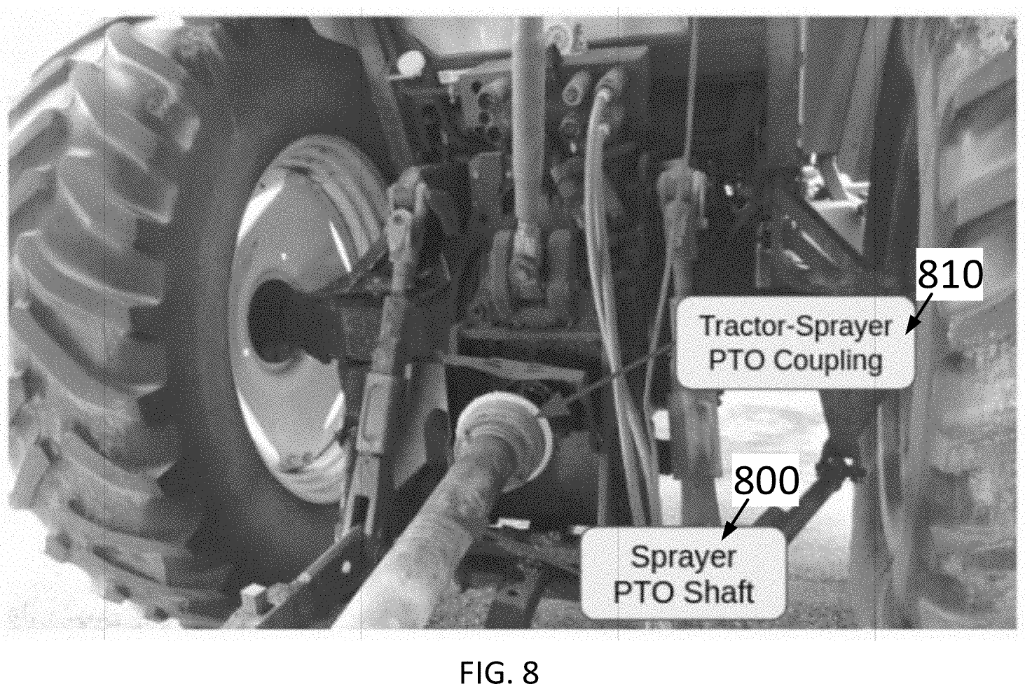

An example of a sprayer 600 is shown in FIG. 6 that can be used in accordance with various embodiments. Here, the sprayer 600 is a rear sprayer such as the Chemical Containers PowerBlast 500 Gallon sprayer. As shown in FIG. 7, the sprayer 600 in some embodiments can have a fan 700 (e.g., a thirty-three inch fan) and a plurality of nozzles 710 divided into left and right sides 715, 720. In the illustrated embodiment, the sprayer 600 includes twenty-four nozzles 710. In the illustrated embodiment, each side 715, 720 is divided into four zones 725a-h, providing a total of eight zones 725a-h, for example. In this example, each zone 725a-h is composed of three nozzles and each nozzle is controlled by an electric valve 534 (e.g., ARAG HYEV-1). For instance, the valves 534 can be direct-acting and have a response time of 0.6 seconds for full cycle. The sprayer 600 can have, for example, a centrifugal pump that operates between 150 and 250 PSI. Both the fan and pump can be Power Take-Off (PTO) driven. As shown in FIG. 8, a PTO may be a splined drive shaft 800 installed on a tractor allowing implements with mating fittings 810 to be powered directly by the engine.

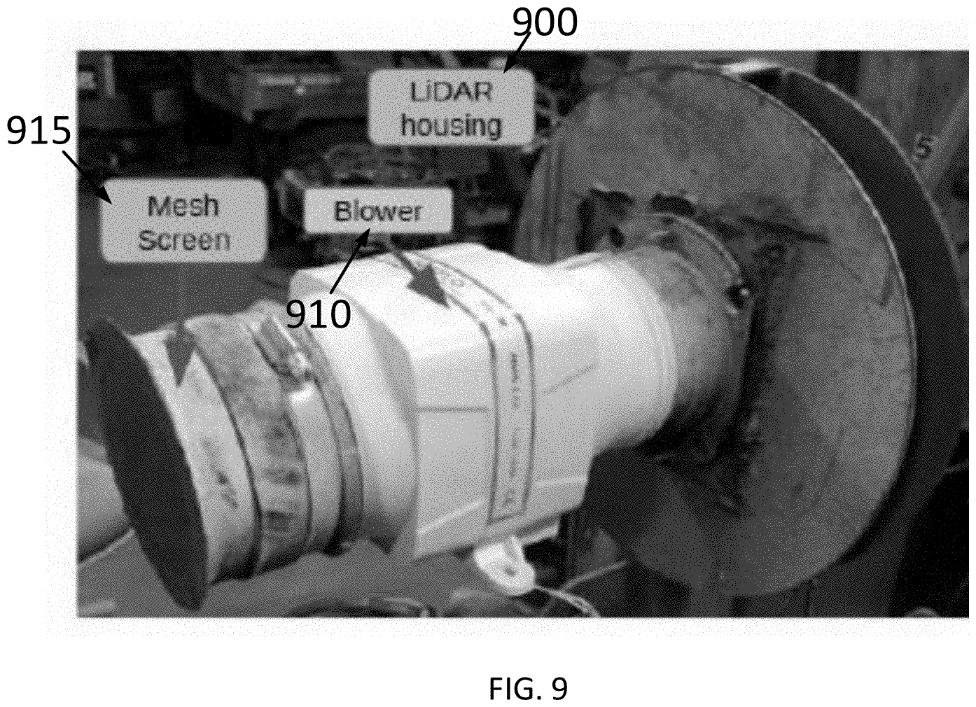

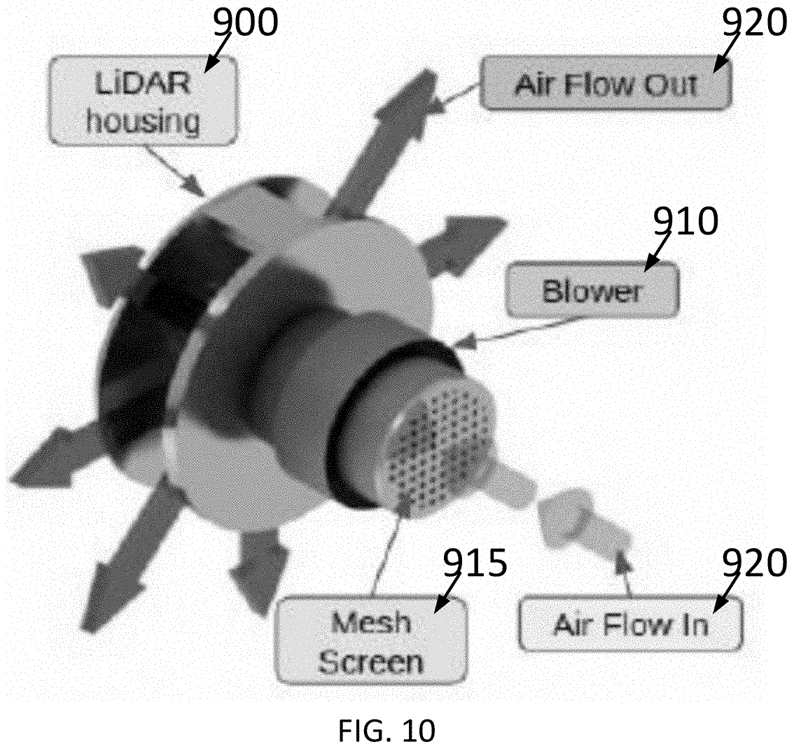

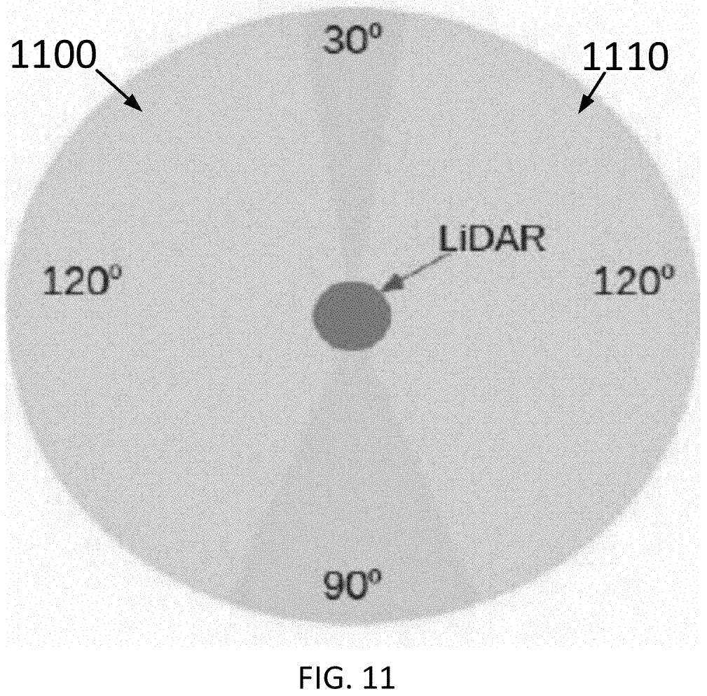

A LiDAR sensor 522 is utilized in various embodiments such as a two-dimensional (2D) or three-dimensional (3D) 360 degrees portable laser scanner (e.g., SLAMTEC RPLiDAR 51), with, for example, a ten Hz (600 rpm) scanning frequency and maximum scan range of ten meters. For instance, in particular embodiments, the LiDAR sensor 522 can output 9200 points per second or 920 points per rotation, giving an angular resolution of 0.391 degrees. A housing cover assembly (structure) is configured and used in particular embodiments to protect the LiDAR sensor 522 from physical shocks. As shown in FIGS. 9 and 10, in some embodiments, the housing cover assembly includes a housing 900 that is attached to a 12 v air blower 910 (e.g., Selflo SFIB1-270-02) with a mesh screen 915 to filter large particles (e.g., TIMESETL TXJ-322-US) to provide an air flow 920 which maintains the LiDAR sensor 522 at a higher air pressure to avoid dust accumulation (e.g., expunge dirt particles). The housing 900 may be constructed of various materials such as steel, aluminum, plastic, and/or the like. Accordingly, in particular embodiments, the LiDAR sensor 522 inside the housing 900 can have an effective field of view of 240° divided into two zones of 120° 1100, 1110 as shown in FIG. 11.

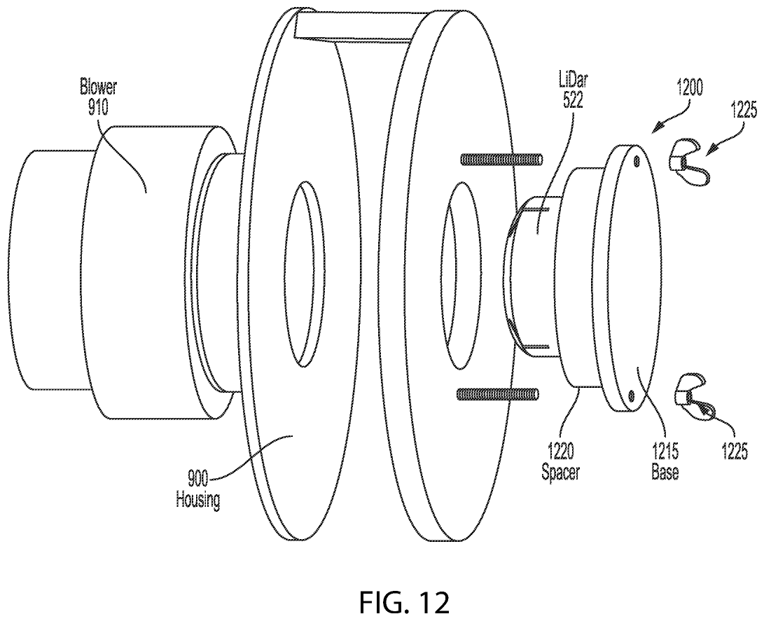

As shown in FIG. 12, in various embodiments, the LiDAR nest 1200 inside the housing 900 is built in a way that allows the LiDAR sensor 522 to be detachable, for easy maintenance and cleaning. In particular embodiments, the LiDAR nest 1200 is configured with a frame as a base 1215 made of a material such as steel, aluminum, plastic, and/or the like, with a spacer 1220, also made of a material such as steel, aluminum, plastic, and/or the like, to isolate the LiDAR sensor 522 from the outside environment and help correctly align the LiDAR sensor 522. The LiDAR nest 1200 can be anchored to the housing 900 using one or more fasteners 1225 such as one or more screws, bolt, anchor, and/or the like. Accordingly, in various embodiments, the housing cover assembly provides protection in that the frame of the LiDAR nest 1200 protects against physical impacts, while the air blower 910 and housing geometry can enhance protection against dirt blocking readings.

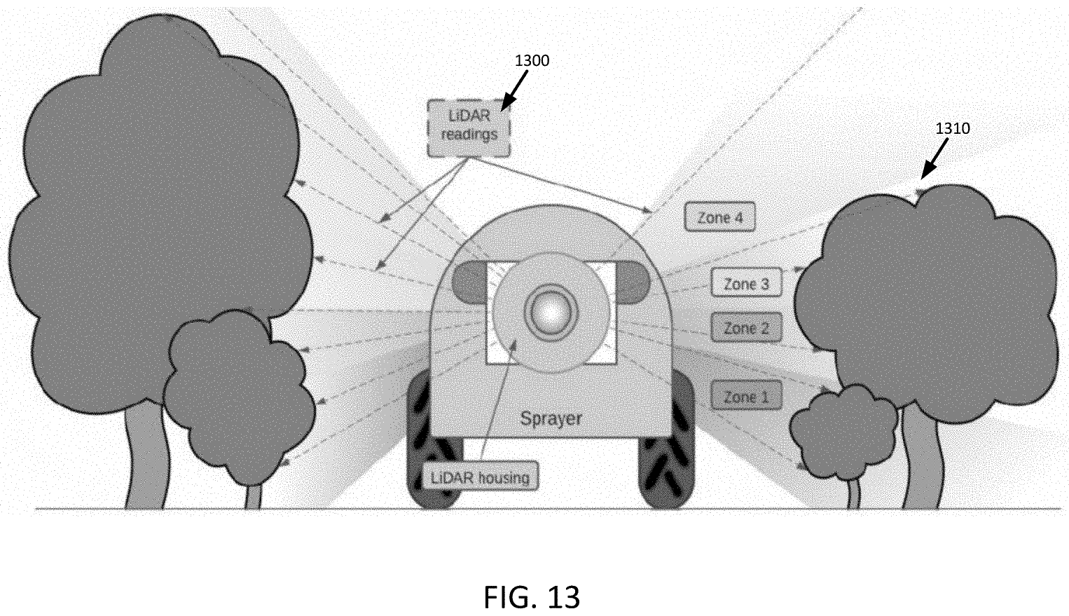

In addition, in various embodiments, the LiDAR is mounted in the front of the sprayer 600, allowing the LiDAR sensor 522 to read 3D points of the adjacent trees every rotation. In particular embodiments, the LiDAR measurements are divided into: number of points pertaining to an object (e.g., tree) in its immediate surroundings, and the topmost point's distance to the ground (height). In some embodiments, an embedded computer uses these readings to then classify the object (e.g., tree) into each zone, and to activate the respective nozzles zones and/or individual nozzles to ensure the correct sprayer pattern for each object height (e.g., tree height). FIG. 13 presents a schematic of the LiDAR readings 1300 for different tree sizes 1310 correlating to each nozzle's zones activated.

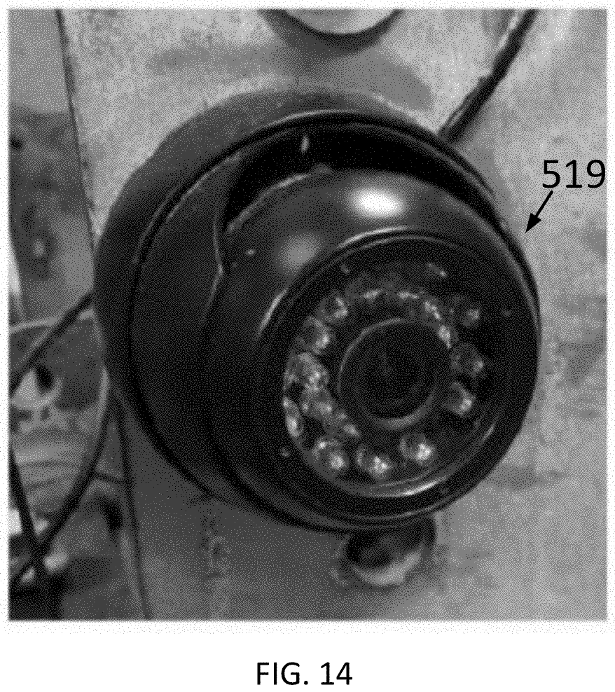

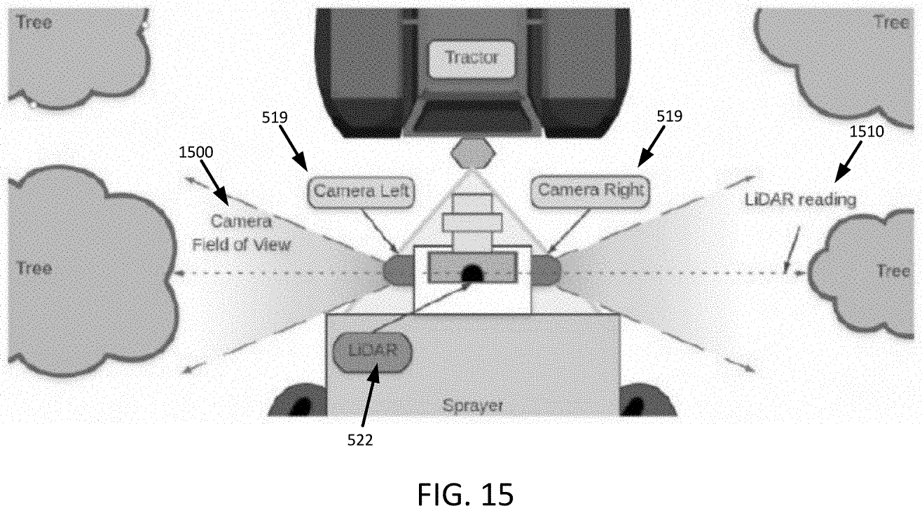

In particular embodiments, one or more cameras 519 (e.g., one or more RGB cameras such as ELP USB130W01MT-DL36) are used for image acquisition as shown in FIG. 14. For example, one or more cameras 519 may be used having sensor resolution of 800×600 pixel and a focal lens of 3.6 mm. Accordingly, the camera(s) 519 may be enclosed by a housing made of a material such as steel, aluminum, plastic, and/or the like that is rated for outdoor usage. In some embodiments, the camera(s) 519 may be placed close to the LiDAR sensor 522, on each side of the sprayer 600 to capture images of trees as shown in FIG. 15.

Accordingly, the cameras 519 can be positioned in a way that their field of view 1500 is aligned with the LiDAR reading 1510. As discussed further herein, in various embodiments, the images from the cameras 519 can be used by the embedded computer 510 on object classification AI 526 to ensure that the object seen is a desired object (e.g., is a tree). In particular embodiments, this information can be used in activating and/or deactivating the nozzles. In addition, in various embodiments, the images can be used on another AI 535 for object detection to identify and count objects such as the fruit on the tree. Further, in various embodiments, the images can be used on a third AI 517 to classify the health status of the plant (e.g., tree). Accordingly, this information can be used in particular embodiments to control the application rate for a specific tree.

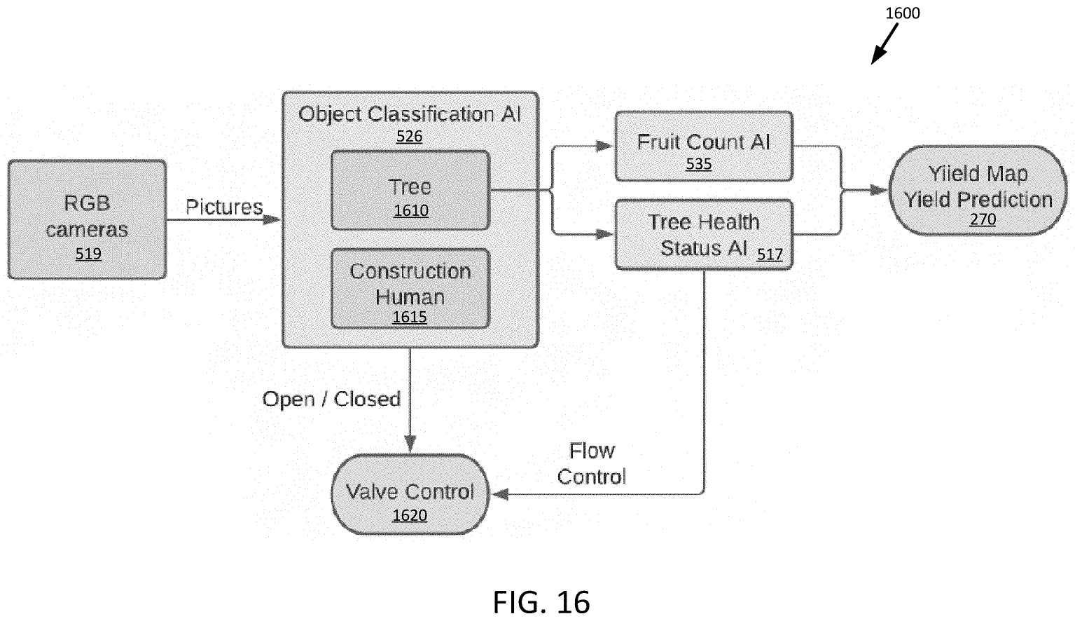

FIG. 16 provides a process flow 1600 involving the use of the camera images (e.g., pictures) to control the valve status and generate yield prediction information according to various embodiments. Here, the process flow 1600 involves processing images produced by the cameras 519 using object classification AI 526 to identify an object seen in the images as a tree 1610 or other (e.g., construction, human 1615). Based at least in part on whether the object is identified as a tree 1610 or other, (e.g., a construction, human 1615), instructions can be provided as to open or close the valve control 1620 for the sprayer 600. In addition, as a result of identifying the object as a tree 1610, the process flow 1600 may further involve using fruit detection AI 535 and tree health AI 517 in generating a yield map having a yield prediction 270.

In various embodiments, a GPS module 514 (e.g., a USB GPS such as Gowoops GPS module) is used for positioning and speed determination. For example, in particular embodiments, a GPS module 514 is used having a one Hz position update rate and an external antenna mounted at the top surface of the sprayer 600 for better satellite connection. Accordingly, in particular embodiments, the position information can be used to verify in which area of the application map 235 the sprayer 600 is located, and adjust the application rate accordingly. The speed can also be used in some embodiments to control the liquid flow to ensure the correct application. Further, in some embodiments, the position information can be used to geotag each tree identified.

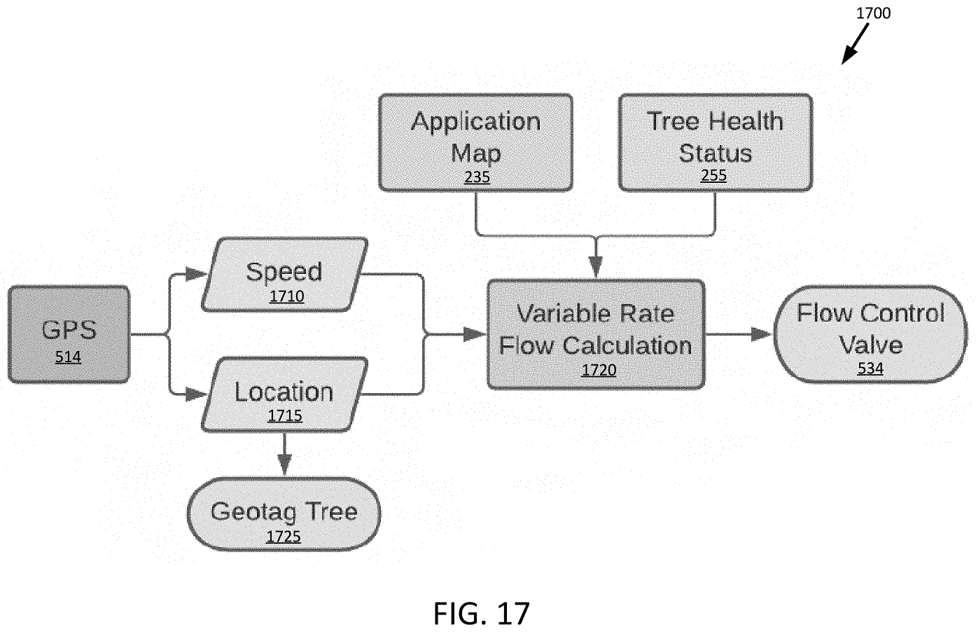

FIG. 17 presents a process flow 1700 for processing the GPS data 513 used by the sprayer 600 according to various embodiments. Here, the process flow 1700 involves processing the speed 1710 and location 1715 provided by the GPS module 514 to generate a variable rate flow determination 1720 to adjust a flow control valve 534 for the sprayer 600. In this particular instance, the application map 235 and tree health status 255 are also used in determining the rate for the adjustment to be made to the flow control valve 534. Further, the process flow 1700 involves generating a geotag 1725 for each tree identified.

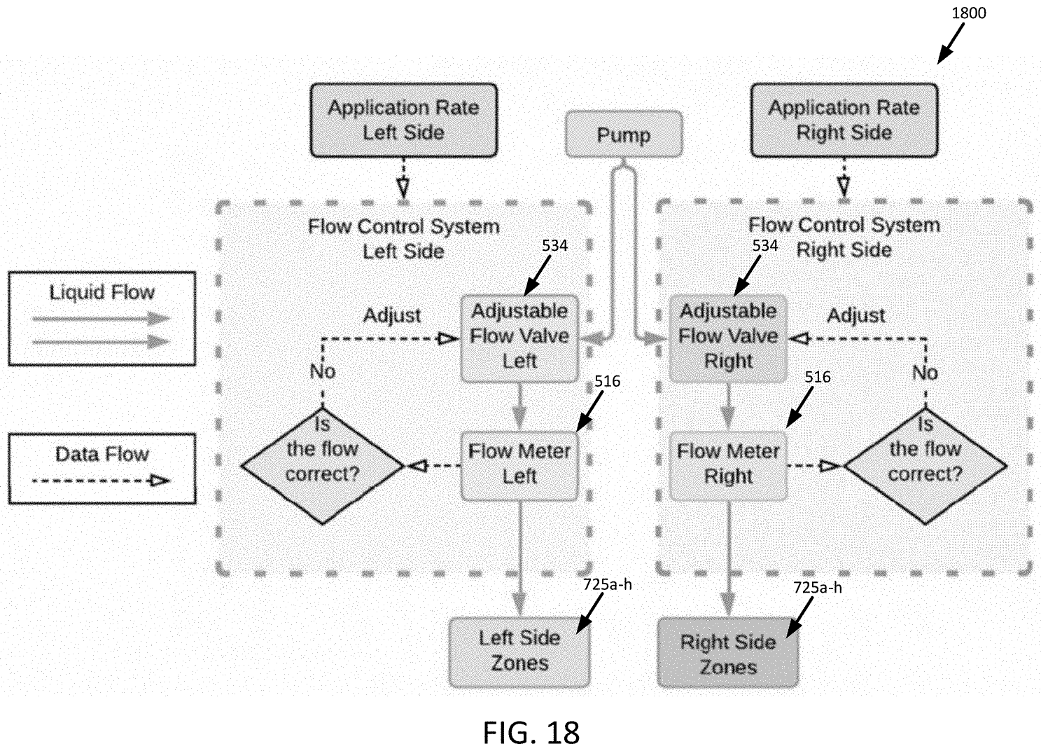

Furthermore, in various embodiments, a flow control system that includes a flow meter 516 and an electronically adjustable flow control valve 534 is used to control and assess the liquid flow for each side of the sprayer 600. For instance, in particular embodiments, the sprayer 600 may have one pair for each side (left and right). Accordingly, the flow control system 1800 may be set up in some embodiments in a way to adjust the liquid flow in a closed loop, as depicted in FIG. 18. Here, the flow meters 516 (e.g., electro-magnetic flow meters such as ARAG Orion 2) may be placed on each side of the sprayer 600 before the valves 534 covering four zones 725a-h each. For example, a flow meter 516 may have a range of five to 100 liters/minute and a maximum operating pressure of 290 PSI. This setup can allow the flow meter 516 to read the overall liquid consumption of the sprayer 600 for each side. The electronically adjustable flow control valves 534 (e.g., Brand Hydraulics PEFC12-30-12) may be placed directly before the flow meters 516. For example, in particular embodiments, these valves 534 may be capable of controlling the liquid flow with a 12V solenoid while maintaining the liquid pressure constant.

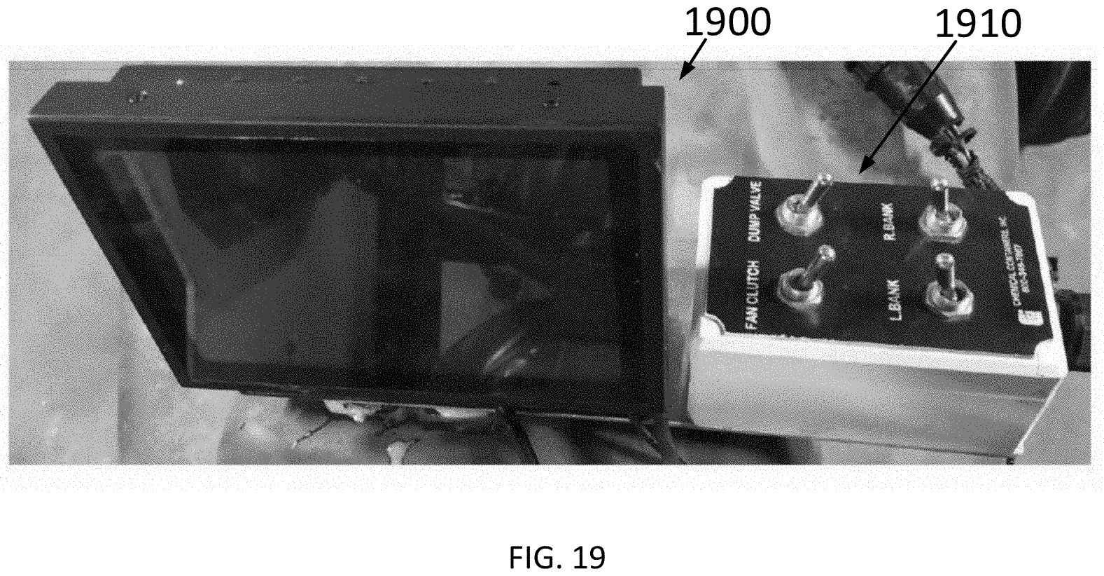

Finally, in various embodiments, the smart sprayer system 110 may include an interface module that allows an operator to provide inputs to the smart sprayer system 110. For instance, in particular embodiments, the smart sprayer system 110 may include a touch screen monitor 1900 (e.g., Beetronics 7VG7M) and one or more manual stitches 1910 that control various components such as the PTO-pump clutch, the PTO-fan clutch, the tractor power supply, the dump valve, and/or the like, as shown in FIG. 19 mounted on the tractor.

Accordingly, in various embodiments, the monitor 1900 is used as the display for the system user interface (UI) that provides feedback on sensor conditions and processed information. In particular embodiments, the UI also supports user manual inputs such as, for example: nozzle control (turn on, off or automatic (smart)); flow meter (turn on volume sprayed readings); setup spraying buffer (spraying buffer is the distance before and after a tree that the system can start spraying); distance between sensors and valves (depending on where the sensors are mounted, this input can regulate the distance between them to better apply the liquid); look ahead (use the distance between sensors and valves with the tractor speed to better apply the liquid); manual speed (instead of using the GPS readings for the tractor speed, set a manual speed); stopped condition (regulates if the sprayed should activate if the tractor is stopped); fruit counter condition (turn on and off the fruit count AI); and data logging condition (turn on and off the data logging process).

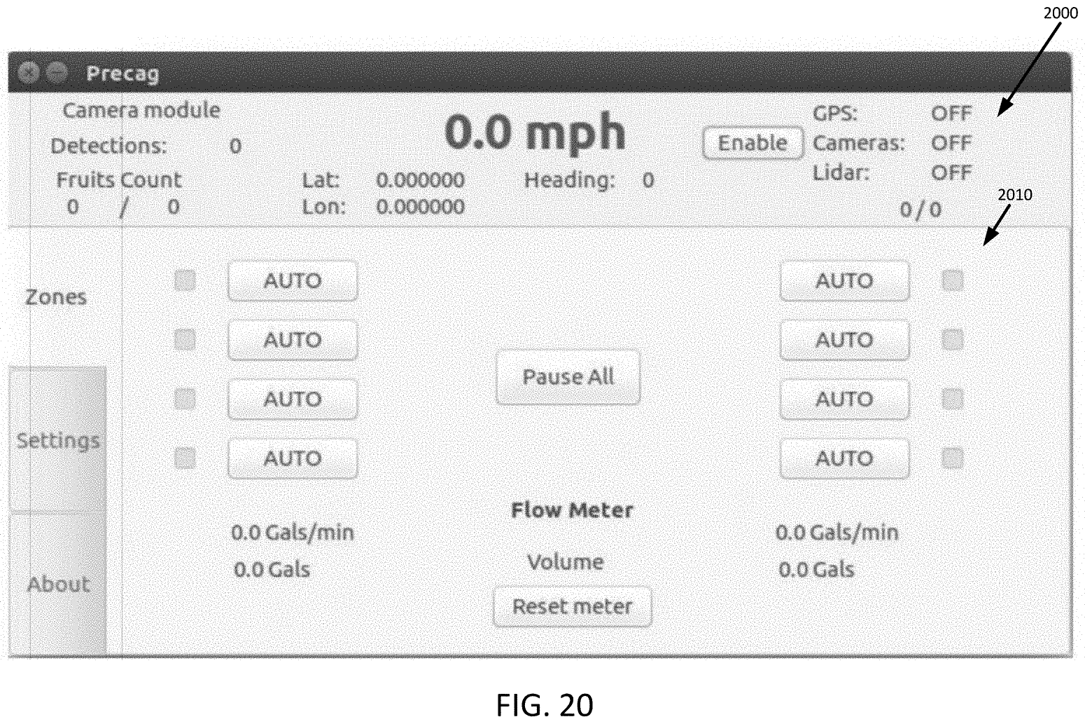

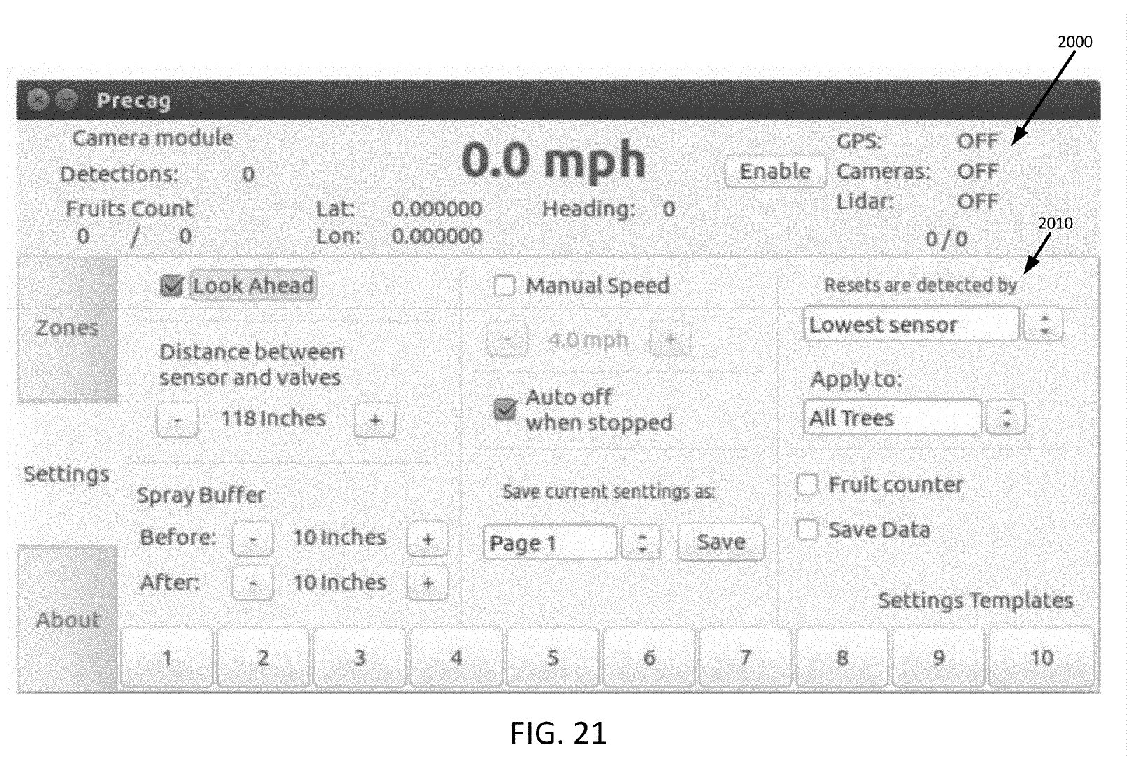

Depending on the embodiment, screens for the UI can be divided into one or more windows such as, for example, a real-time information feedback window at the top of the monitor 1900, and a control-input tab window at the bottom of the monitor 1900. In particular embodiments, the information feedback window 2000 shows sensor data in real-time, with some processed data information, as shown in FIG. 20. Here, the information provided on the information feedback window 2000 is tractor speed, GPS position and direction, GPS, cameras and Lidar condition, tree detections and fruit count. In particular embodiments, the control-input window 2010 can have three tabs: Zones, Settings and About. Accordingly, in some embodiments, the Zones tab, shown in FIG. 20, can allow the control of the nozzles zones (turn on/off, automatic) and the flow meter readings, while also providing feedback of their conditions to the operator. A similar window may be provided in various embodiments with respect to controlling individual spray nozzles. While in some embodiments, the Settings tab, shown in FIG. 21, can allow for the input of more in-depth control of the spraying system.

### Exemplary System Operation

The logical operations described herein may be implemented (1) as a sequence of computer implemented acts or one or more program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof. Greater or fewer operations may be performed than shown in the figures and described herein. These operations may also be performed in a different order than those described herein.

Accordingly, in various embodiments, the smart sprayer system 110 can be configured using six different program modules: a user interface module for processing user inputs and system feedback as previously discussed, a zones condition control module configured for controlling which spray zones and/or individual spray nozzles are to be activated, a spraying condition control module configured for using camera feedback to activate or deactivate the sprayer 600, a tree health module configured for determining tree health status, a flow control module for controlling sprayer flow, and a yield module for generating a yield estimation. Further detail is now provided on these various modules.

### Zone Condition Control Module

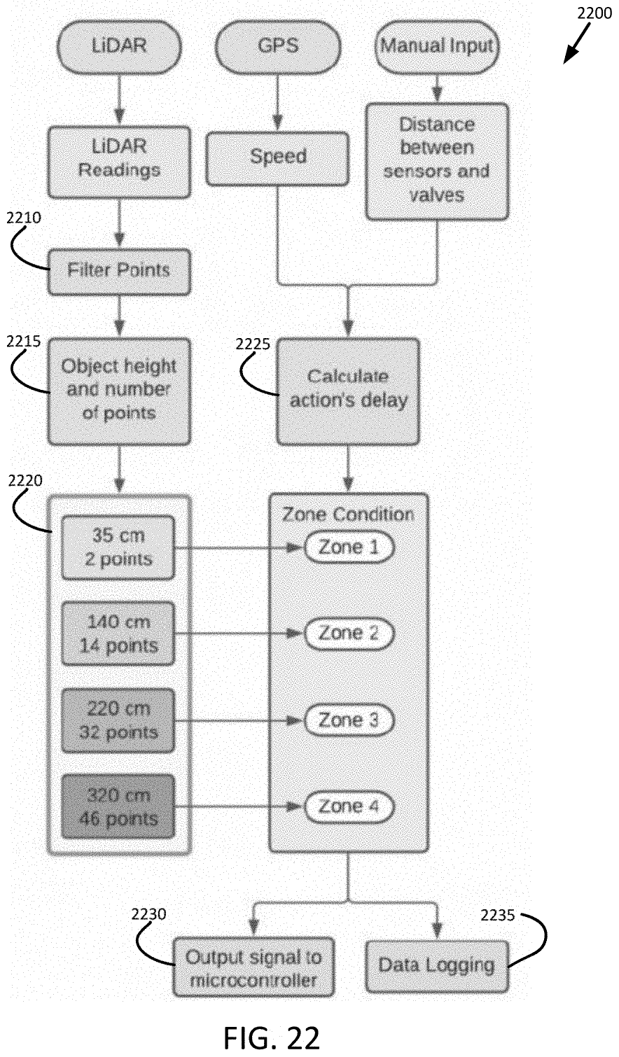

Turning now to FIG. 22, additional details are provided regarding a process flow for controlling the spray zones 725a-h and/or individual spray nozzles according to various embodiments. Accordingly, FIG. 22 is a flow diagram showing a zone condition control module for performing such functionality according to various embodiments a the disclosure. For example, the flow diagram shown in FIG. 22 may correspond to operations carried out by a processing element 410 in a computing entity 400, such as the embedded computer residing within the smart sprayer system 110 as previously described, as it executes the zone condition control module stored in the computing device's volatile and/or nonvolatile memory.

In various embodiments, the process flow 2200 involves the zone condition control module filtering LiDAR readings collected from a scan performed by the LiDAR sensor 522 in Operation 2210. For example, the readings may have been collected after one full scan (360 degrees rotation) of the LiDAR sensor 522 is performed to obtain all the points pertaining to objects inside a 0.5-6 meters range. The zone condition control module then processes these 3D points in Operation 2215 to obtain: (i) height and/or (ii) number of points of both the right and left side of the system. For instance, in particular embodiments, the zone condition control module obtains the height as the maximum detected point and the number of points as the number of points detected above 30 cm from the ground, on each side. The zone condition control module then classifies the scan into zones 725a-h and/or individual spray nozzles to be activated in Operation 2220 if the scan satisfies (fulfills) the height and/or number of points required for each specific zone 725a-h and/or individual spray nozzle.

Following the classification of the scan into zones 725a-h and/or individual spray nozzles, the zone condition control module reads a GPS speed measurement and determines the delay to execute the zone's and/or individual spray nozzle's activation in Operation 2225. This delay is due to the distance between the LiDAR sensor 522 and the nozzles, and it also takes into account the valve's cycle time, according to Equation 1:

$$\begin{matrix}Delay = \frac{( Dsn ) - ( Bbef )}{Speed} - ( Vat ) & Equation 1 \\ Duration = \frac{( Baft ) - ( Bbef )}{Speed} & Equation 2\end{matrix}$$

The valve's cycle time (Vat) may be empirically found to be such as, for example, 1.2 seconds. Further, the distance between the sensor and nozzle (Dsn), the spray buffer before (Bbef) and spray buffer after (Baft) may be manually set into the user interface. Accordingly, in various embodiments, the zone condition control module determines the delay for a respective speed and buffer setting and awaits this amount of time before triggering the designated action (zones and/or spray nozzles opening and closing) in Operation 2230. For instance, in particular embodiments, the zone condition control module may be configured to trigger this action for a specific duration of time given by Equation 2. In addition, in some embodiments, the zone condition control module saves the scan, GPS coordinates, and/or speed measurement in Operation 2235. For example, the zone condition control module may be configured to save the scan, GPS coordinates, and/or speed measurement into a spreadsheet file.

### Spraying Condition Control Module

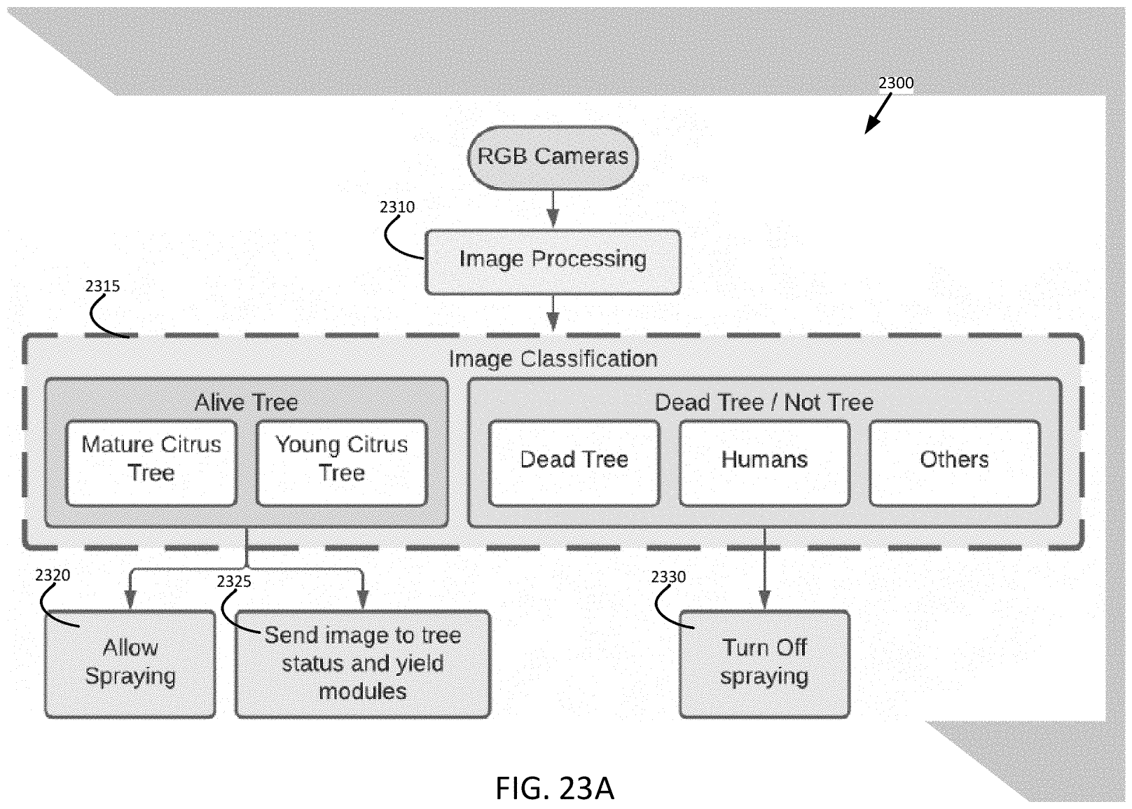

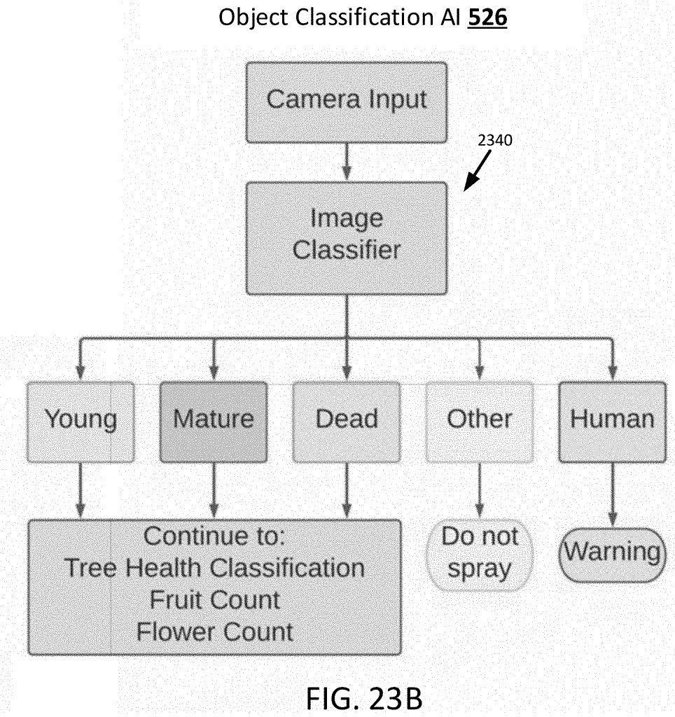

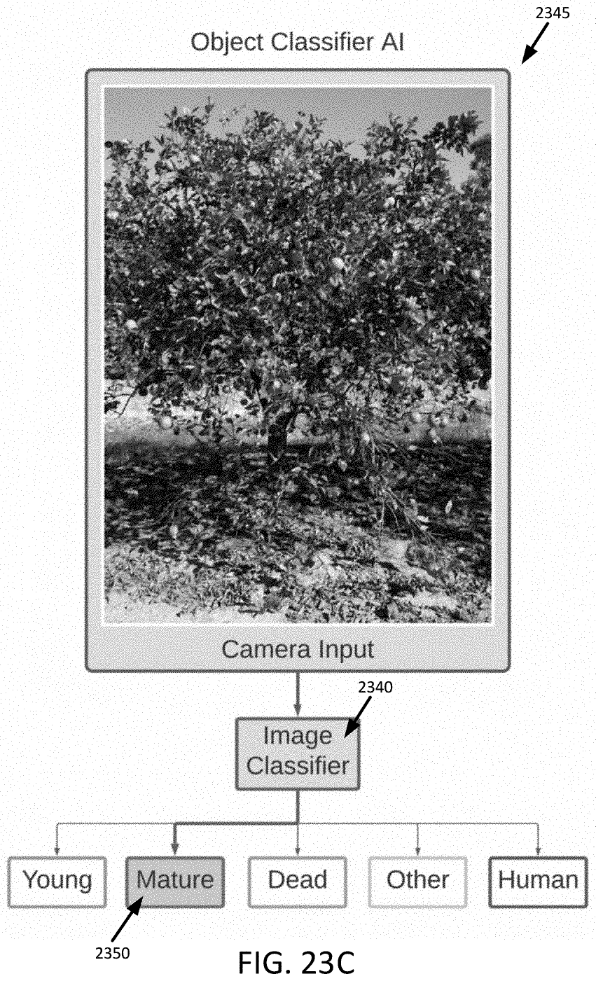

Turning now to FIG. 23A, additional details are provided regarding a process flow for using camera feedback to activate or deactivate the sprayer 600 according to various embodiments. Accordingly, FIG. 23A is a flow diagram showing a spraying condition control module for performing such functionality according to various embodiments of the disclosure. For example, the flow diagram shown in FIG. 23A may correspond to operations carried out by a processing element 410 in a computing entity 400, such as the embedded computer residing within the smart sprayer system 110 as previously described, as it executes the spraying condition control module stored in the computing device's volatile and/car nonvolatile memory.

In various embodiments, the spraying condition control module is configured to run parallel with LiDAR operation. Accordingly, in these embodiments, the process flow 2300 involves the spraying condition control module taking input images from the cameras 519 on each side of the sprayer 600, processing the images in Operation 2310, and outputting an image classification for each side in Operation 2315. For example, in particular embodiments, the spraying condition control module may be configured to classify the images as: (i) mature citrus trees; (ii) young citrus trees; (iii) dead trees; (iv) at risk trees; (v) humans; and (vi) others. Others may be, for instance, a water pump station, weather sensor, post, and/or the like. In various embodiments, the spraying condition control module may output a binary classification between an alive tree class and a dead/not tree class, as depicted in the illustrated embodiment. The images may be acquired having various resolutions and/or sizes depending on the embodiment. Therefore, the spraying condition control module may be configured to resize, crop, preprocess, and/or the like the images. For example, the images may be received with a resolution of 800×600 pixels, and the spraying condition control module may resize the images to 400×300 and then crop them from the center to a final resolution of 256×256 pixels.

In some embodiments, the spraying condition control module may use the image classification to override the zone control module. For instance, if the output of the classification is anything other than an alive tree, then the spraying condition control module sets the spray zone conditions to off in Operation 2320. As a result, the corresponding spray zones 725a-h and/or individual spray nozzles (e.g., the valves 534 for the nozzles) for the sprayer 600 are turned off. If the output of the classification is an alive tree, then the spraying condition control module allows spraying in Operation 2325 and sends the image(s) and/or image classifications to the tree health status and the yield estimation modules in Operation 2330.

Accordingly, in various embodiments, the spraying condition control module is configured to perform the image classification using object classification AI 526. Turning to FIG. 23B, the object classification AI 526 may be configured in particular embodiments with one or more image classifier machine learning models 2340. For instance, in particular embodiments, the one or more image classifier machine learning models 2340 may be a supervised or unsupervised deep learning model such as a neural network. For example, the neural network may be a convolutional neural network trained using the YOLOv4 framework. For instance, the neural network may be a Resnet50 (or ResNet101) network, 50 layer deep residual learning network Darknet network, 53 layer convolutional neural network, 50 layer deep residual learning network, and/or the like. FIG. 23C provides an example of the one or more image classifier machine learning models 2340 processing an image 2345 acquired by a camera 519 and generating a classification of an object detected in the image as a mature citrus tree 2350. It is noted that in particular embodiments, the one or more image classifier machine learning models 2340 may be configured to classify the image as a whole so that a classification for the image can be generated quickly and/or accurately so that it can be provided for further processing.

Furthermore, although not shown in FIG. 23A, the spraying condition module in particular embodiments may perform object detection 542 on the image(s) to identify whether an object in an image is a human. Accordingly, in these embodiments, the spraying condition module may be configured to perform the object detection 542 on the image(s) using one or more human detection machine learning models. For example, in particular embodiments, the one or more human detection machine learning model(s) may be a neural network, such as a Darknet network, trained using the YOLOv4 object detection framework. The spraying condition module may be configured in this manner as a safety precaution to ensure the sprayer 600 is not activated when a human is present. Here, object detection 542 may be performed to help ensure that any trees found in an image do not skew the information that there is a human in the scene depicted in the image. In some embodiments, the spraying condition module may perform this operation in parallel with image classification to provide two different processes for identifying the presence of a human. Further, in some embodiments, the spraying condition module may be configured to send a warning in instances when the object in an image is classified and/or detected as a human.

### Tree Health Status Module

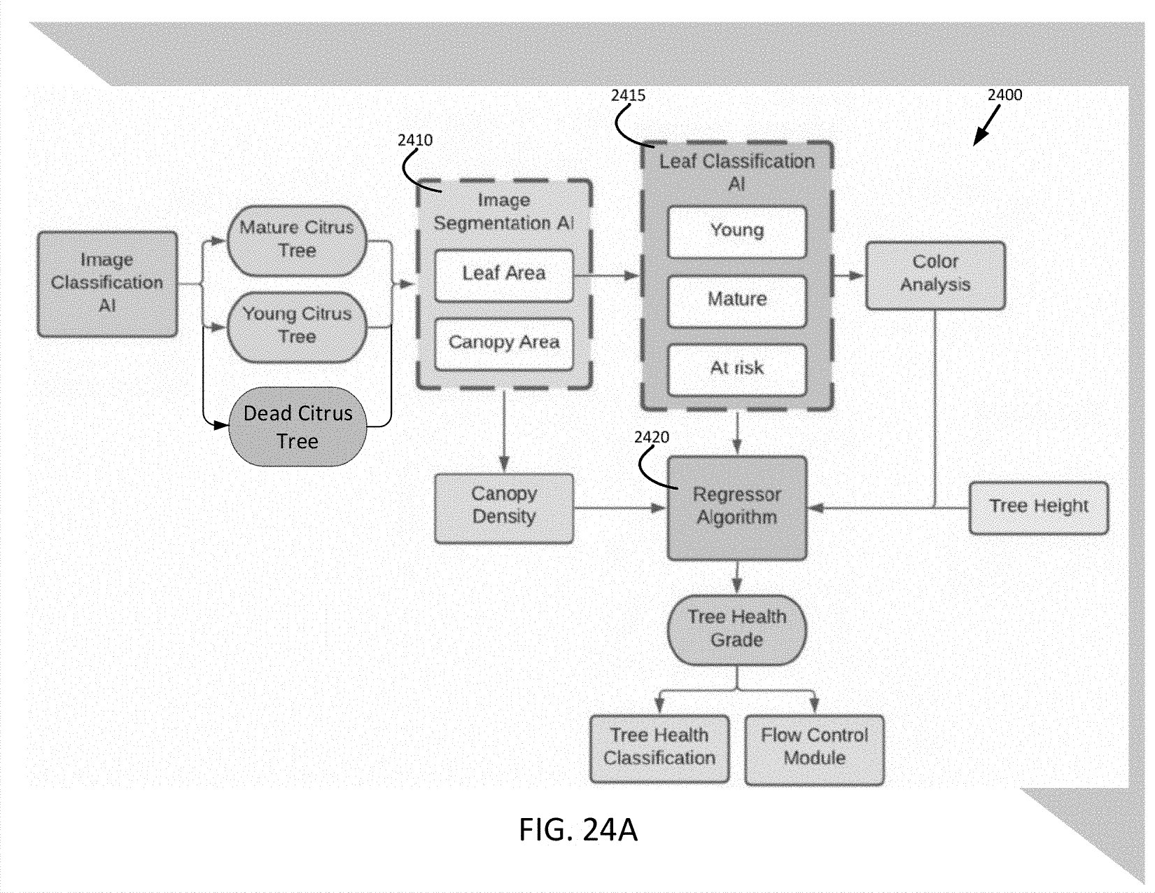

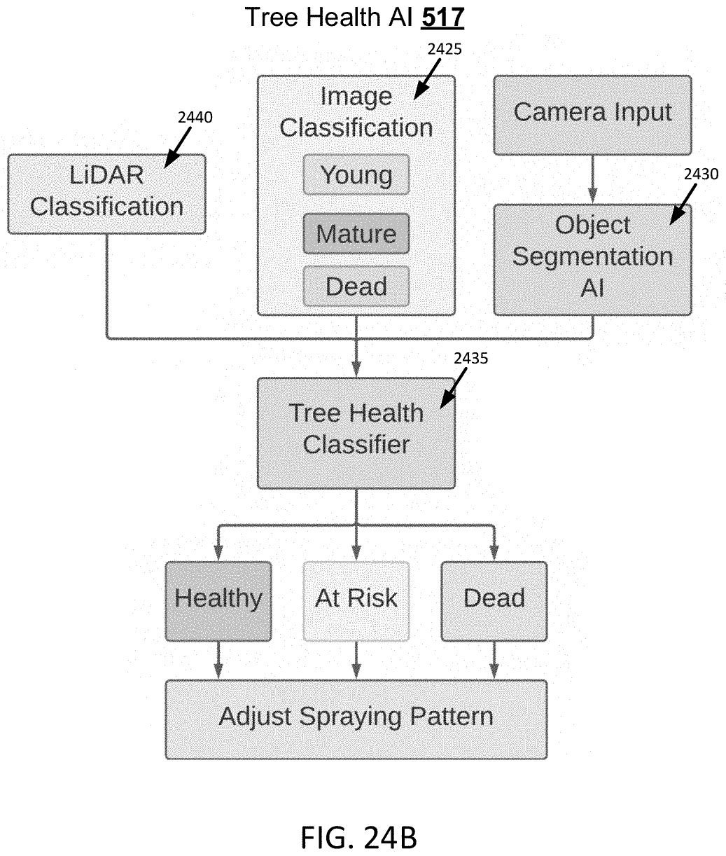

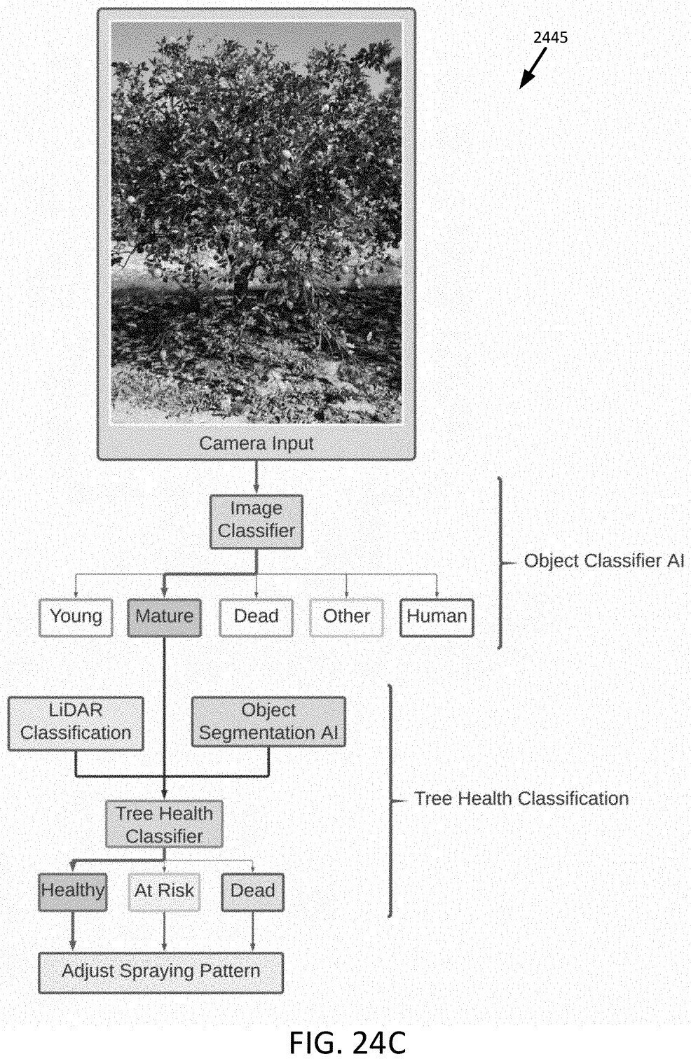

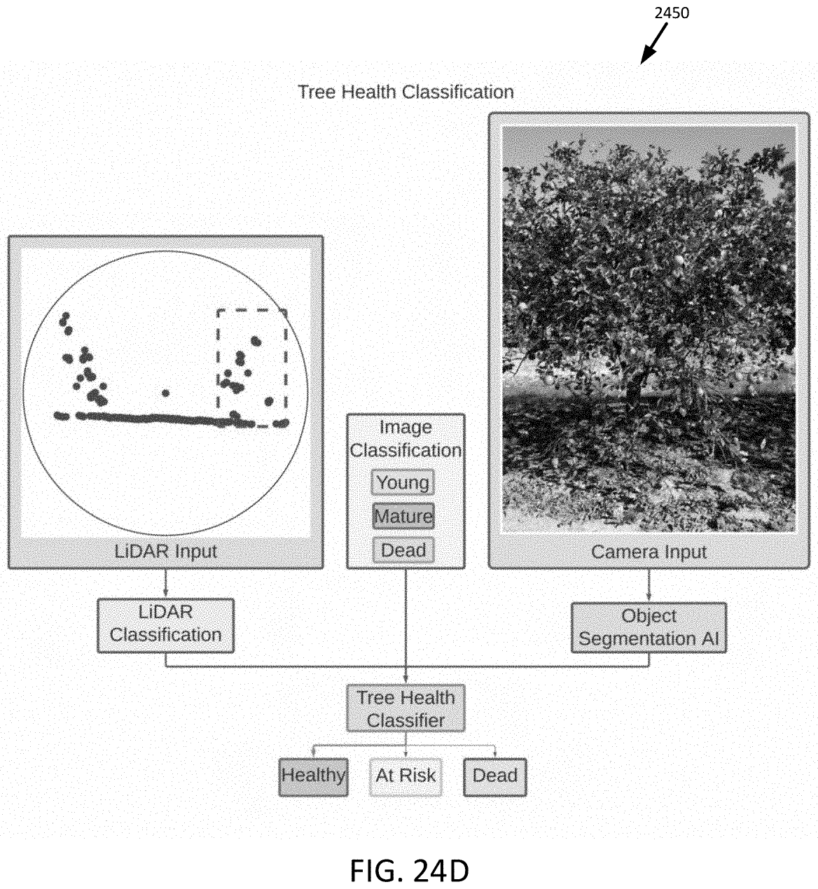

Turning now to FIG. 24A, additional details are provided regarding a process flow for determining a tree health status 255 according to various embodiments. Accordingly, FIG. 24A is a flow diagram showing a tree health status module for performing such functionality according to various embodiments of the disclosure. For example, the flow diagram shown in FIG. 24A may correspond to operations carried out by a processing element 410 in a computing entity 400, such as the embedded computer residing within the smart sprayer system 110 as previously described, as it executes the tree health status module stored in the computing device's volatile and/or nonvolatile memory.

In various embodiments, the original camera image(s) for the tree are used to determine the tree health status 255, in addition to the tree classification. Here, in particular embodiments, the process flow 2400 involves the tree health status module grading the health of the tree based at least in part on height, canopy size, canopy (leaf) density, canopy color, and/or the like. This grade is then used in some embodiments to control the spraying flow and/or classify the tree into conditions such as, for example, at risk and healthy.

In various embodiments, the tree health status module makes use of tree health AI 517 in determining the tree health status 255 for the tree. Accordingly, in particular embodiments, the tree health AI 517 may be configured as separate components of AI. Thus, the process flow 2400 begins with the tree health status module using semantic image segmentation AI to detect the canopy area and leaf area for the image(s) in Operation 2410. Accordingly, the canopy area can be used in generating the tree leaf (canopy) density, which can then be used in evaluating the tree health status 255. For instance, the tree leaf density can be used in identifying the tree health status 255 of a tree as being at-risk. Here, in particular embodiments, the semantic image segmentation AI may be configured as one or more semantic image segmentation machine learning models such as one or more supervised or unsupervised trained model configured to detect the canopy and/or leaf area(s). In addition, the tree health status module in particular embodiments uses a second AI (leaf classification AI) to classify the leaves into mature, young, or at-risk leaves in Operation 2415. The second AI may be configured as one or more leaf classification machine learning models such as one or more supervised or unsupervised trained model configured to classify the leaves of the tree based at least in part on the leaf area detected by the semantic image segmentation AI.

At this point, in various embodiments, the tree health status module then processes this extracted information by using the tree health classification AI configured, for example, as a classifier model trained using a regression framework, to grade the health of the tree in Operation 2420. Accordingly, in particular embodiments, the tree health classification AI may be configured to process a color analysis of the canopy and/or a height for the tree, along with the tree leaf density and/or size and classification of leaves, to generate the tree health status 255 (may also be referred to as tree health grade). As previously noted, the tree health status 255 may be used in particular embodiments to generate a tree health classification for the tree, as well as control the spraying flow for spraying the tree as detailed below.

Turning now to FIG. 24B, further detail is provided on a configuration of the tree health AI 517 that may be used by the tree health status module according to various embodiments. As previously noted, the tree health status 255 is performed in particular embodiments after classification 2425 is performed on the one or more images, if the output from the classification 2425 is a tree that is either young, mature, or dead. Accordingly, the tree health status 255 can act as a second layer for providing a further/better health analysis on the detected tree in certain embodiments. As previously noted, in particular embodiments, the configuration of the tree health AI 517 may be an ensemble. For instance, the configuration of the tree health AI 517 may include object segmentation AI 2430. Accordingly, the object segmentation AI 2430 may include semantic image segmentation AI and leaf classification AI. In particular embodiments, the object segmentation AI 2430 identifies a canopy area and/or leaf area for the tree and the leaf classification AI separates (classifies) the leaves into categories such as, for example: mature; young; at risk; obstructed; and/or the like. Obstructed leaves may be leaves in the shadows, which make them appear darker. In addition, the object segmentation AI 2430 may involve analyzing the mature and/or young leaves by color, distribution in space, and area coverage. This can be used as input for the tree health classification AI 2435.

For example, in particular embodiments, the object segmentation AI 2430 may be configured using a Mask Region Based Convolutional Neural Network (R-CNN) framework running on a ResNet50 network. Accordingly, after an object is identified in the image, the object segmentation AI 2430 generates a bounding box around the object. The object segmentation AI 2430 then performs segmentation to identify which pixels within the bounding box are the object. In some embodiments, one or more machine vision algorithms may be used after the mask is generated. Accordingly, the object segmentation AI 2430 performs color segmentation to identify the pixels having a “vegetation green” color (e.g., Green/Red>=1.1). In addition, the object segmentation AI 2430 may perform index segmentation using one or more (e.g., two) different indexes generated in a genetic algorithm that highlights pixels from leaves. For instance, in particular embodiments, each index is an equation using colors as inputs (red, green, blue), and generating higher values to pixels of leaves (e.g., around 1.0) and lower values to pixels of other objects (e.g., around 0). In some embodiments, the object segmentation AI 2430 may use a reflectance barrier based at least in part on the overall reflectance (light) of these pixels to estimate that shadows are around the lower end of this spectrum. In addition, the object segmentation AI 2430 may use a histogram to get the “mode” value which is used to identify shadows. This can ensure reliability in multiple light conditions.

In addition, in particular embodiments, the configuration of the tree health AI 517 may include LiDAR classification AI 2440 configured as one or more LiDAR classification machine learning models used to process LiDAR data to generate information on point density per angle, maximum height, height angle detection, and/or distance. Accordingly, the one or more LiDAR classification machine learning models may be supervised and/or unsupervised learning models. For example, the one or more LiDAR classification machine learning models may be gradient boosting regression tree or partial least squares regression.

Further, in particular embodiments, the configuration of the tree health AI 517 may include tree health classification AI 2435 configured to process the data provided by the classification of the tree 2425, the object segmentation AI 2430, and/or the LiDAR classification AI 2440 to generate a health classification for the tree. As previously mentioned, the tree health classification AI 2435 may be configured as one or more tree health classification machine learning models such as, for example, a machine learning model trained using a gradient boosting regression tree framework. In other embodiments, the tree health classification AI 2435 may be configured as a machine learning model trained using a NeuroEvolution of Augmenting Topologies (NEAT) framework. Accordingly, the tree health classification AI 2435 may generate a tree health status 255 (classification) for the tree, and this tree health status 255 can be used to adjust the spraying pattern, as well as used to generate yield estimations. FIG. 24C provides an example 2445 of a camera input processed through the object classification AI 526 and then the tree health AI 517 according to various embodiments. FIG. 24D provides an example 2450 of camera input (image) and LiDAR input (points in 2D space) processed through the tree health AI 517 according to various embodiments.

### Flow Control Module

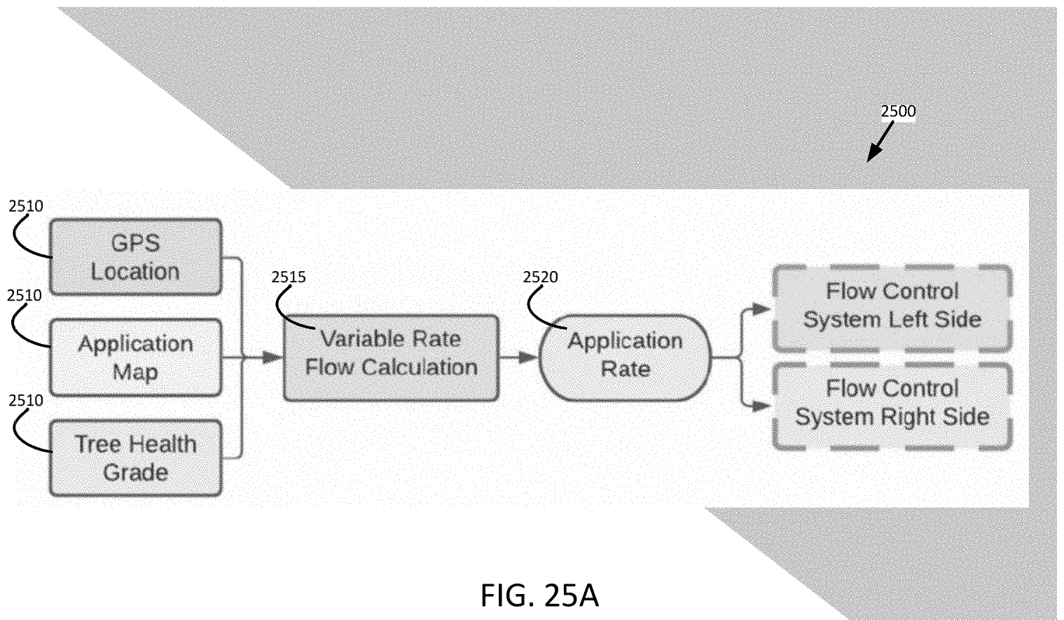

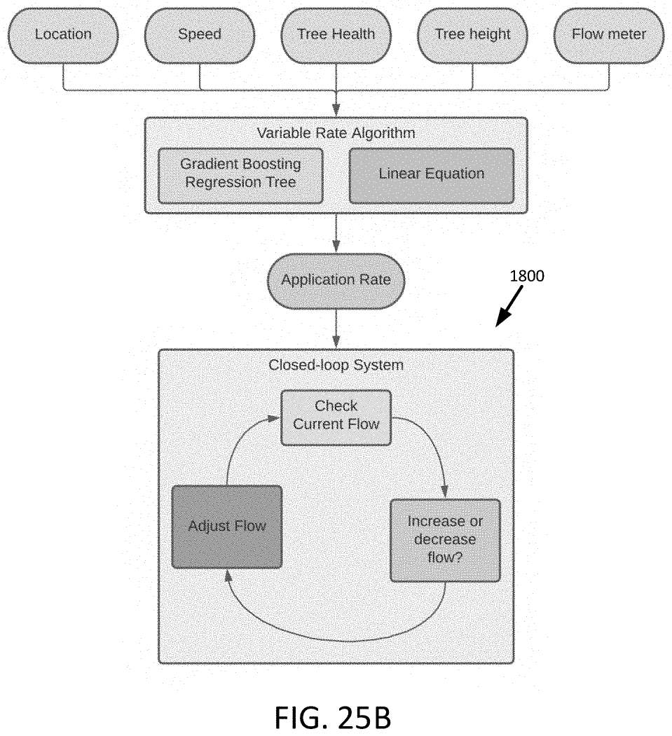

Turning now to FIG. 25A, additional details are provided regarding a process flow for determining flow control for applying the liquid to a region of area of interest according to various embodiments. Accordingly, the region of the area of interest may be a specific location within a tree grove at which the sprayer 600 is to apply liquid. Accordingly, FIG. 25A is a flow diagram showing a flow control module for performing such functionality according to various embodiments of the disclosure. For example, the flow diagram shown in FIG. 25A may correspond to operations carried out by a processing element 410 in a computing entity 400, such as the embedded computer residing within the smart sprayer system HO as previously described, as it executes the flow control module stored in the computing device's volatile and/or nonvolatile memory.

Accordingly, the flow control module is configured in various embodiments to serve as the software side of the flow control system 1800. In particular embodiments, the process flow 2500 begins with the flow control module obtaining GPS data 513 such as a location measurement and/or speed measurement of the sprayer 600, along with the application map 235 and tree health status 255 (tree health grade) of one or more trees found in the region, in Operation 2510. The flow control module then provides these variables as input into a variable rate flow model to generate the overall application rate for the region in Operation 2515.

Accordingly, in various embodiments, the variable rate flow model generates the amount of spray that needs to be applied. For instance, in particular embodiments, the variable rate flow model may be configured as a mixture of a machine learning model and linear function. For example, the model may be configured as a gradient boosting regression tree (GBRT) with four stages of depth. Such a model is used in some embodiments to allow the variable rate flow model to be manually adjusted such as, for example, if a user wants to add fifty gallon/min more than required, or set a fixed value for specific regions and/or trees. Accordingly, the low depth of the model can allow more control to the linear function that receives human inputs. Therefore, the variable rate flow model can act as a “jack of all trades” in particular embodiments, as the model can be configured to work with only LiDAR/camera readings, manual input, application map, or a mixture of data.

In some embodiments, the variable rate flow model is configured to fine-tune the rate with the tree health status 255 created by the tree health status module. Therefore, depending on the embodiment, the variable rate flow model receives input such as a location measurement, speed, tree health, tree height, flow reading (e.g., current sprayer consumption measurement), and/or the like, and outputs a value of flow (e.g., 120 gallon/minute) as the application rate. Finally, the flow control module sends the generated application rate to the flow control system 1800 in Operation 2520. As a result, the flow control system 1800 reads the applicable flow meter 516 to adjust the pressure, flow, and/or flow valve(s) 534 to achieve the application rate required and control the flow of liquid being applied by the sprayer 600 to the region.

Accordingly, in various embodiments, the flow control system 1800 can serve as a closed-loop control. For example, in particular embodiments, when the variable rate flow model generates an application rate of 150 gallon/min and the flow control module sends the application rate to the flow control system 1800, the flow control system 1800 reads the current flow valve reading, such as, for example, 120 gallon/min. Since there is a 20% difference between the current reading and the application rate, the flow control system 1800 reacts by opening the valve 20% more. The flow control system 1800 then reads the flow valve again, and now the current reading may be 165 gallon/min. The new reading is now 10% over the application rate, so the flow control system 1800 closes the valve by 10%, and so on. Accordingly, the flow control system 1800 may be configured in various embodiments to work in this fashion to account for liquids, which do not typically flow with a linear behavior. FIG. 25B demonstrates the flow control system 1800 operating as a closed-loop system according to various embodiments.

### Yield Estimation Module

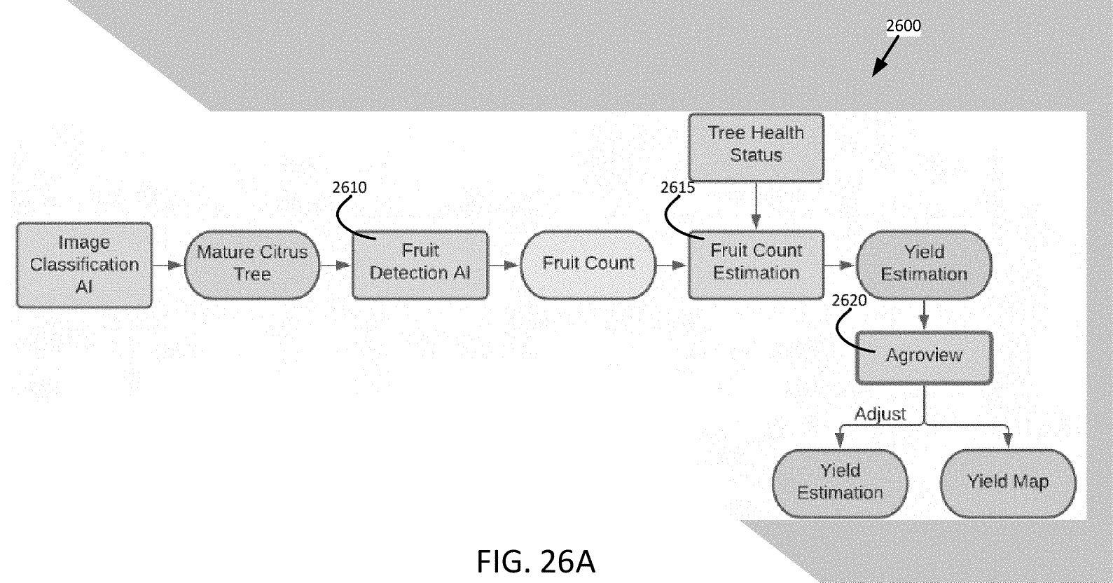

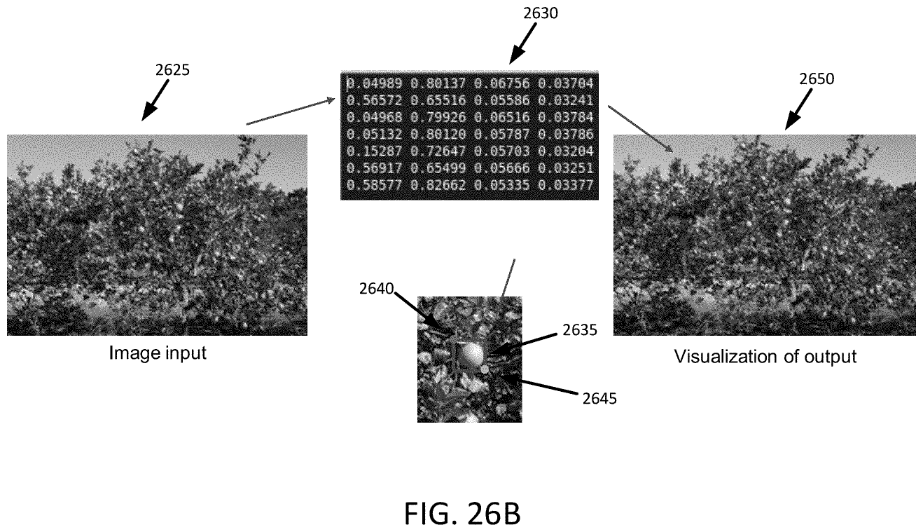

Turning now to FIG. 26A, additional details are provided regarding a process flow for determining a yield estimation according to various embodiments. Accordingly, FIG. 26A is a flow diagram showing a yield estimation module for performing such functionality according to various embodiments of the disclosure. For example, the flow diagram shown in FIG. 26A may correspond to operations carried out by a processing element 410 in a computing entity 400, such as the embedded computer residing within the smart sprayer system 110 as previously described, as it executes the yield estimation module stored in the computing device's volatile and/or nonvolatile memory.

Accordingly, in various embodiments, the yield estimation module is configured for detecting and counting objects such as citrus fruits and/or flowers using one or more cameras images (e.g., RGB images). In particular embodiments, the process flow 2600 for the yield estimation module may be triggered (e.g., invoked) as a result of the object classification AI 526 classifying a tree as mature. In turn, the yield estimation module processes the one or more images of the mature tree using fruit detection AI 535 in Operation 2610. For instance, in particular embodiments, the fruit detection AI 535 may comprise one or more fruit detection machine learning models configured for detecting fruits on the tree. Here, the one or more fruit detection machine learning models may be one or more supervised or unsupervised trained models. For example, in some embodiments, the one or more fruit detection machine learning models may be a convolutional neural network (CNN) such as a Darknet network trained using the YOLOv4 framework. Accordingly, the output of the fruit detection AI 535 may be a list of detections containing a detection score and/or bounding box for each of the detected fruits. For example, the bounding box may be defined as two points in the 2D space of the image (e.g., X and Y axis), which define a rectangle. The average size of this rectangle for the detected fruits can be used in determining the diameter of the fruit. As noted, the fruit detection AI 535 may be configured in particular embodiments for detecting and counting other objects besides fruits, such as flowers on the tree. Further, in some embodiments, the yield estimation module may be configured to resize the images to enhance object detection. For example, the yield estimation module may resize the images from the original 800×600 pixels to 672×512 pixels.

For instance, turning briefly to FIG. 26B, the fruit detection AI 535 may process image input 2625 and produce a detection output 2630. Here, each line in the detection output 2630 represents a fruit that has been detected. The columns are points in X and Y axis that define a bounding box for the detected fruit in the shape of a rectangle, and the units are relative to the size of the image. For example, the bounding box 2635 generated for a detected fruit can be defined by a point “zero” (x0,y0) 2640 and a point “one” (x1,y1) 2645. A visualization of the output 2650 is also provided in the figure. Therefore, the fruit detection AI 535 may count the number of fruit (lines) in the detection output 2630 to identify a count of fruit for the tree, and generate a diameter for the fruit based at least in part on the average diameter of the bounding boxes for the detected fruits.

Returning to FIG. 26A, the yield estimation module then processes the number of detected objects (e.g., fruits) and their size (e.g., fruit diameter) for the tree using, for example, one or more fruit count estimation machine learning models such, to estimate the tree's total yield in weight and count in Operation 2615. Accordingly, the one or more fruit count estimation machine learning models may be one or more supervised and/or unsupervised learning models such as, for example, a regression model. Here, in particular embodiments, the yield estimation may also process a second input comprising the tree health status in estimating the tree's total yield. Accordingly, in some embodiments, the yield estimation module may save this information in Operation 2620 for later upload to the cloud environment 115 (e.g., Agroview platform), which then uses the UAV data to complement the estimation, generate a yield estimation for the area, and/or generate one or more yield maps.

### CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A computer-implemented method for controlling one or more spray zones for a sprayer used for spraying an agricultural area, the computer-implemented method comprising:
filtering, via one or more computer processors, one or more light detection and ranging (LiDAR) readings collected from a scan of the agricultural area to obtain a plurality of points pertaining to objects located inside a range of the agricultural area;
classifying, via the one or more computer processors, each spray zone of the one or more spray zones to be activated in response to the spray zone having at least one of a height for the plurality of points satisfying a height requirement or a number of points for the plurality of points satisfying a point number requirement; and
for each spray zone classified as a zone to be activated:
determining, via the one or more computer processors, a delay to execute an activation of the spray zone based at least in part on a speed of the sprayer, and
after an amount of time based at least in part on the delay, triggering the activation of the spray zone to cause spraying of at least a portion of the range of the agricultural area.

2. The computer-implemented method of claim 1, wherein the delay is determined based at least in part on a distance between a LiDAR sensor used in obtaining the one or more LiDAR readings minus a spray buffer before the spray zone, the speed of the sprayer, and a cycle time for the valve used for the spray zone.

3. The computer-implemented method of claim 1, wherein a duration of time for the activation of the spray zone is determined as a spray buffer after the spray zone plus a spray buffer before the spray zone, and wherein the duration of time is further determined based at least in part on the speed of the sprayer.

4. A computer-implemented method for generating a tree health status of a tree, the computer-implemented method comprising:
processing, via one or more computer processors, one or more images of the tree using a semantic image segmentation machine learning model to detect a canopy area and a leaf area for the tree;
generating, via the one or more computer processors, a tree leaf density for the tree based at least in part on the detected canopy area;
generating, via the one or more computer processors and using a leaf classification machine learning model, a leaf classification for the tree based at least in part on the detected leaf area for the tree;
performing, via the one or more computer processors, a color analysis for the leaf area based at least in part on the leaf classification; and
generating, via the one or more computer processors, a tree health status for the tree based at least in part on processing the tree leaf density and the color analysis using a tree health classification machine learning model.

5. The computer-implemented method of claim 4, further comprising:
automatically controlling, via the one or more computer processors, a spray flow for a sprayer configured for spraying a liquid on the tree based at least in part on the generated tree health status.

6. The computer-implemented method of claim 4, wherein the one or more images of the tree are generated by one or more cameras affixed to a sprayer used for spraying a liquid on the tree.

7. The computer-implemented method of claim 4, further comprising:
processing, via the one or more computer processors, one or more light detection and ranging (LiDAR) readings collected from a scan of an area comprising the tree to generate a tree height for the tree, wherein the tree health classification machine learning model is configured to process the tree height for the tree to generate the tree health status.

8. The computer-implemented method of claim 4, wherein the tree health classification machine learning model comprises a gradient boosting regression tree model.

9. The computer-implemented method of claim 4, wherein the tree health status is generated for the tree in response to the tree being classified as a mature citrus tree, a young citrus tree, or a dead citrus tree.

10. The computer-implemented method of claim 4, further comprising classifying the tree as at risk or healthy based at least in part on the tree health status.

11. A computer-implemented method for generating a yield estimation for a fruit tree, the computer-implemented method comprising:
processing, via one or more computer processors, one or more images of the fruit tree using a fruit detection machine learning model to identify a plurality of fruits for the tree and generate a bounding box for each of the fruits in the plurality of fruits;
generating, via the one or more computer processors, a fruit count for the fruit tree based at least in part on the plurality of fruits;
generating, via the one or more computer processors, a fruit size for the fruit tree based at least in part on the bounding box generated for each of the fruits in the plurality of fruits; and
processing, via the one or more computer processors, the fruit count, the fruit size, and a tree health status for the fruit tree using a fruit count estimation machine learning model to generate the yield estimation for the fruit tree.

12. The computer-implemented method of claim 11, wherein the one or more images of the fruit tree are generated by one or more cameras affixed to a sprayer used for spraying a liquid on the fruit tree.

13. The computer-implemented method of claim 11, wherein the yield estimation comprises a total yield in weight and count of fruit for the fruit tree.

14. The computer-implemented method of claim 11, wherein generating the fruit size for the tree comprises:
calculating a diameter for each of the fruits in the plurality of fruits based at least in part on the boarding box generated for each of the fruits in the plurality of fruits to generate a set of diameters; and
generating the fruit size as an average of the set of diameters.

15. The computer-implemented method of claim 11, wherein the fruit detection machine learning model comprises a neural network model and the fruit count estimation machine learning model comprises a regression model.

16. The computer-implemented method of claim 11, further comprising processing, via the one or more computer processors, the one or more images to resize the one or more images prior to processing the one or more images using the fruit detection machine learning model.

17. A computer-implemented method for adjusting a flow control valve for a sprayer used for spraying a liquid on a tree located in a region of an agricultural area, the computer-implemented method comprising:
generating, via one or more computer processors and using a variable rate flow model, an application flow rate for the sprayer based at least in part on processing at least one of: global positioning system (GPS) data for the sprayer, an application map providing information on an amount of liquid to apply to the region, and a tree health status of the tree, wherein the variable rate flow model comprises a machine learning model and a linear function; and
automatically providing, via the one or more computer processors, the application flow rate to a flow control system, wherein the flow control system is configured to adjust the flow control valve based at least in part on the application flow rate to control flow of the liquid being applied to the tree located in the region.

18. The computer-implemented method of claim 17, wherein the variable rate flow model comprises gradient boosting regression tree with four stages.

19. The computer-implemented method of claim 17, wherein the GPS data comprises at least one of a location measurement of the sprayer within the agricultural area or a speed measurement of the sprayer.

20. The computer-implemented method of claim 17, further comprising:
processing, via the one or more computer processors, one or more images of the tree using a semantic image segmentation machine learning model to detect a canopy area and a leaf area for the tree;
generating, via the one or more computer processors, a tree leaf density for the tree based at least in part on the detected canopy area;
generating, via the one or more computer processors and using a leaf classification machine learning model, a leaf classification for the tree based at least in part on the detected leaf area for the tree;
performing, via the one or more computer processors, a color analysis for the leaf area based at least in part on the leaf classification; and
generating, via the one or more computer processors, a tree health status for the tree based at least in part on processing the tree leaf density and the color analysis using a tree health classification machine learning model.

21. A housing cover assembly for a light detection and ranging (LiDAR) sensor, the housing cover assembly comprising:
a housing; and
a nest for the LiDAR sensor configured as a frame to allow seating of the LiDAR sensor through an opening in the housing, wherein the nest comprises a base and a spacer connected to the LiDAR sensor and configured to isolate the LiDAR sensor from an outside environment and correctly align the LiDAR sensor.

22. The housing cover assembly of claim 21, wherein the housing cover assembly is configured to protect the LiDAR sensor from physical shocks.

23. The housing cover assembly of claim 21, wherein an air blower with a mesh air flow is attached to the housing cover assembly to provide an air flow for maintaining an air pressure to avoid dust accumulation.

24. The housing cover assembly of claim 21, wherein the housing cover assembly provides an effective field of view for the LiDAR sensor of at least two-hundred and forty degrees.

25. The housing cover assembly of claim 21, wherein the nest for the LiDAR sensor is detachable to enable removal of the LiDAR sensor from the housing.
